(19) United States
(12) Patent Application Publication
(10) Pub. No.: US 2023/0024272 A1
(43) Pub. Date: Jan. 26, 2023

(54) ATHLETIC SKILLS DEVELOPMENT RANKING AND TRACKING

(71) Applicant: Russell Nathaniel Thomas, JR., Crofton, MD (US)

(72) Inventor: Russell Nathaniel Thomas, JR., Crofton, MD (US)

(21) Appl. No.: 17/384,841

(22) Filed: Jul. 26, 2021

(51) Int. Cl. A63B 71/06; A63B 24/00; G06F 16/2457

(52) U.S. Cl. CPC A63B 71/0616; A63B 24/0062; G06F 16/24578; A63B 2024/0071

(57) ABSTRACT

Embodiments of the invention disclosed relate to systems and methods for facilitating the development of an athlete in a given sport. In one embodiment, a system can include one or more computing devices communicating via a computer network to receive input associated with Skill Scores and to compute and store an Athlete Development Rating (ADR) based at least on said input. In one embodiment, the ADR is based on a composite score of one or more Skills Scores and/or one or more Skill Group Scores. In certain embodiments, Skill Scores are associated with date data to provide a historical view of the athlete's development. In some embodiments, Skill Scores can be based on quantitative, objective assessments and/or qualitative, subjective expert assessments. Program modules can be configured to display historical ADR data, Skill Scores, and/or Skill Group Scores.

### BACKGROUND

### 1. Technical Field

Embodiments of the invention disclosed generally relate to systems and methods for tracking and ranking athletic skills development. More particularly, embodiments of the invention relate to tracking athletic ability development by determining an athletic development rating based upon a plurality of objective and/or subjective measurements and/or expert assessments.

### 2. Description of the Related Art

Athletics are extremely important in our society. In addition to competing against each other on the field, athletes often compete with each other off the field. For example, student athletes routinely compete with each other for a spot on the team, or even if they are already on the team, for more game time or a higher starting position. High school seniors are often in competition with other student athletes for coveted college athletic scholarships and the like. Also, amateur athletes in some sports often compete with each other for jobs as professional athletes in a sport. An important factor in all of these competitions is the athletic performance, or athleticism, of the particular athlete, and the ability of that athlete to demonstrate or document those abilities to others.

In some assessments, athletic ability can include considerations of speed, agility, reaction time, and power. Accordingly, athletes strive to improve athletic performance in these areas, and coaches and recruiters tend to seek those athletes that have the best set of these characteristics for a particular sport.

One method for evaluating and comparing athletes' athleticism involves having the athletes perform a common set of exercises and drills. Athletes that perform the exercises or drills more quickly and/or more accurately are usually considered to be better than those with slower or less accurate performance for the same exercise or drill. For example, cone drills are routinely used in training and evaluating athletes. In a typical cone drill an athlete follows a pre-determined course between several marker cones and, in the process, executes a number of rapid direction changes, and/or switches from forward to backward or lateral running.

Coaches, scouts and agents routinely make decisions about current or prospective players based, at least in part, on a player's athletic ability. Athletic ability is often determined based upon a player's performance in a number of categories relevant to the player's activity. For example, the athletic ability of a baseball pitcher may be determined based on the speed, accuracy, and amount of variety of his pitches, and the athletic ability of a football running back may be determined based upon his speed, agility and strength.

Several athletic parameters have been used to determine athletic ability. For example, a timed run, such as a 60-yard dash is a known athletic parameter for measuring the speed of a player, and the distance a baseball travels after being hit with a bat is another known athletic parameter useful in assessing a batters athletic ability. The speed of a pitch and the spin on the ball are additional examples of known measurable athletic parameters.

Coaches, scouts and agents typically measure a plurality of athletic parameters to help determine an athlete's strengths and weaknesses. Scouts and coaches are often comparing one athlete to another athlete to predict which athlete has more athletic ability in a particular activity. A variety of athletic parameters are separately measured and the scout or coach makes a subjective determination about the athletic ability of the athlete.

It is known to rank athletic ability by performance metrics, which include measurements of an athlete's size, speed, strength, and power. There are specific standards set for each performance metric for each sport and position. One system defines athleticism as having ten components: Strength (ability to create force); Speed (ability to minimize the time cycle of a given movement); Power (ability to create maximal force in minimal time); Mental Resilience (ability to push out of the comfort zone); Aerobic Capacity (maximal amount of physiological work measured by oxygen consumption); Anaerobic Capacity (maximal work performed during maximum-intensity short term physical effort); Balance and Coordination (ability to perform movements with precision and grace); Agility (ability to be nimble on the feet and move quickly from one movement pattern to another); Stability (ability to prevent movement in one part of the body while creating movement in another, thus protecting vulnerable areas); and Mobility (flexibility in motion, the range of motion through muscles and joints). This system groups nine of the ten components into three categories: Layer 1 (Mobility, Stability, Balance and Coordination); Layer 2 (Strength and Aerobic Capacity); and Layer 3 (Power, Speed, Agility and Anaerobic Capacity).

Scholars and practitioners have developed a battery of tests, with some calculating a composite score (e.g., index or rating) from multiple tests (for example, speed, agility, vertical jump, and the like) to represent a single score of athleticism. Several familiar tests requiring running, jumping, agility, coordination, flexibility, balance; and endurance and strength were used to derive such composite scores (for example, the Barrow Motor Ability Test). It is known to consider athletic performance as the sum of four domains: (1) physical, (2) technical (sport-specific skills), (3) tactical (sport IQ, X's and O's), and (4) mental.

The sport of football involve various physical activities and skills that can be difficult to learn, teach or perform. It is known to define Skill Progressions that contain Skill Elements and Key Performance Indicators (KPIs) that vary in complexity as an athlete advances stage by stage in learning the sport of football. A Skill Element is part of a Skill Progression that makes up a Skill. KPIs are the root actions or movements that identify reasons for good or poor performance within a specific Skill Element. KPIs illustrate what successful performance looks like. KPIs are highlighted as an athlete develops or participates in more advanced game types, which further hone an athlete's overall skill development.

The following references are considered relevant prior art and are hereby incorporated herein, each in its entirety. All the web addresses provided were last accessed on Jun. 24, 2021. A Follow-up Study of the Barrow Motor Ability Test of Freshmen Students in Basic Physical Education Classes at Kansas State University During 1966-67 by Kenneth Joe Russell; Athletic Ability Assessment: A Movement Assessment Protocol for Athletes by Ian McKeown, et al., in The International Journal of Sports Physical Therapy, Vol. 9, No. 7, December 2014, page 862; What is Athleticism? The Ten Components of Athleticism by James Breese (strengthmatters.com/ten-components-athleticism-matter/); What is Athleticism and How Is It Tested? by Joe Eisenmann (blog.voltathletics.com/home/2019/2/25/what-is-athleticism-and-how-is-it-tested); The Science of the NFL Combine: What High School Coaches Should Know by Joe Eisenmann (blog.voltathletics.com/home/2018/2/23/the-science-of-the-nfl-combine); The NBA Combine, Correlation, and Tryouts: Individuality Matters! By Joe Eisenmann (blog.voltathletics.com/home/2018/5/14/the-nba-combine-correlation-and-tryouts); Measuring Progress by Patrick McHenry (training-conditioning.com/article/measuring-progress/); 9 Steps to Measure a Complete Athlete (perform-360.com/9-steps-to-measure-a-complete-athlete/); How the Model Works (fdm.usafootball.com/how-it-works); Football Leadership Academy Part 1 by Jerry Campbell (footballtoolbox.net/football-leadership-academy); Developing Junior Football, Part 3: How to utilize football tracking data in coaching? (xampion.com/developing-junior-football-part-3-how-to-utilize-football-tracking-data-in-coaching/); The 3 Most Important Football Skills And How To Develop Them (www.americanfootballinternational.com/3-important-football-skills-develop/); U.S. Pat. No. 8,292,788 Athleticism Rating and Performance Measuring System; U.S. Pat. No. 8,308,615 System and Method for Predicting Athletic Ability; U.S. Pat. No. 8,649,890 System and Method for Providing An Athlete With a Performance Profile; U.S. Pat. No. 9,135,347 Exercise Tracking and Analysis Systems and Related Methods of Use; U.S. Pat. No. 10,248,729 Method and System of Quantifying Athletic Skills and Competitive Results in a Social Network; U.S. Pat. No. 10,758,808 Athleticism Rating and Performance Measuring Systems; US Patent Application Publication 2010/0129780 Athletic Performance Rating System; and US Patent Application Publication 2012/0179277 Athletic Ranking System.

Despite the available athlete training and evaluation methods and the related known performance measuring systems, there remains a need for improved rating systems and methods for tracking athletic skill development.

### SUMMARY OF ILLUSTRATIVE EMBODIMENTS

Disclosed are systems and methods for facilitating the development of an athlete in a given sport. In one aspect, the invention concerns a system for facilitating athletic skill development, the system can include a database for storing data associated with an athlete; a computer processor and a computer memory for executing program modules; a computer display monitor for displaying data associated with the athlete; one or more program modules for execution by the computer processor in conjunction with the computer memory, wherein the one or more program modules comprise instructions for: (i) building a database for storing information associated with an athlete; (ii) receiving input for defining a plurality of Skills and a plurality of Skill Groups; (iii) providing an entry in the database for each of the Skills; (iv) storing in the database, for each of the Skills, a Skill Score for the athlete; (v) storing in the database date data associated with the Skill Score; (vi) receiving input for assigning a Skill Group to each Skill; (vii) determining a plurality of Skill Group Scores by adding the Skill Scores of each Skill in a Skill Group; (viii) receiving input for identifying one of the plurality of Skill Group Scores as an Athlete Development Rating (ADR); (ix) displaying with the computer display monitor the ADR, one or more Skill Group Scores, and one or more Skill Scores; and (x) displaying with the computer display monitor historical data based at least in part on the stored date data for the ADR, one or more Skill Group Scores, and/or one or more Skill Scores. In one embodiment the program modules further comprise instructions for displaying in real time the ADR, in conjunction with storing a Skill Score substantially concurrently with an evaluation of the athlete in a Skill.

In another aspect, the invention is directed to a method of facilitating athletic skill development, the method can involve providing a database for storing data associated with an athlete; defining a plurality of Skills and a plurality of Skill Groups; providing an entry in the database for each of the Skills; storing in the database, for each of the Skills, a Skill Score for the athlete; storing in the database date data associated with the Skill Score; assigning a Skill Group to each Skill; determining a plurality of Skill Group Scores by adding the Skill Scores of each Skill in a Skill Group; identifying one of the plurality of Skill Group Scores as an Athlete Development Rating (ADR); displaying the ADR, one or more Skill Group Scores, and one or more Skill Scores; and displaying historical data based at least in part on the stored date data for the ADR, one or more Skill Group Scores, and/or one or more Skill Scores.

In one embodiment, the method of can further include determining an average of the Skill Scores for a Skill Group and displaying the average. In some embodiments, determining a plurality of Skill Group Scores includes adding the Skill Scores multiplied by a weight.

In certain embodiments, the method can further include displaying in real time the ADR, in conjunction with storing a Skill Score substantially concurrently with an evaluation of the athlete in a Skill.

In one embodiment, the method can include Skill Groups such as Accuracy, Arm Strength, Mechanics, Pass Play Footwork, Pass Protection, and QB IQ. In some embodiments, the method can include at least one Skill Group selected from the group comprising Run Play Footwork, Routes, Football Personnel Packages, and QB Index.

In certain embodiments, Accuracy includes the Skill Tennis Balls; and in one embodiment, Accuracy can include Tire Throws. In one embodiment, Arm Strength includes Skills Ball Velocity, and Longball Standing. In some embodiments, Arm Strength can include Sitting Throws Distance.

In one embodiment, Mechanics can include Skills Stance/Knee Bend, Load Efficiency, Weight Transfer, and Follow Through. In some embodiments, Mechanics can further include BOS, Alley, and Shoulder-to-Shoulder, and/or 3-Seconds. In certain embodiments, Run Play Footwork can include the Skills A-Gap Right-Left, Reverse Pivot Off Tackle Right-Left, Toss Sweep Right-Left, Option Pitch, and Inside Zone. In one embodiment, Run Play Footwork can further include Seat-the-Ball, Reverse Pivot A-Gap Right-Left, Off Tackle Right-Left, Toss Boot Opposite, Option Read, Outside Zone, and/or Play Action.

In some embodiments, Pass Play Footwork can include the Skills 3-Step Drop, 5-Step Drop, and Sprint. In certain embodiments, Pass Play Footwork Skill Group can further include 1-Step Drop, Screens, and/or RPO PF. In one embodiment, Routes can include the Skills Slant, Comeback, Curl, Out, Corner, and Post. In certain embodiments, Routes can additionally include the Skills Flat, Dig, and/or Go.

In one embodiment, Football Personnel Packages can include the Skills 00, 01, 11, 12, and 21. In some embodiments, Football Personnel Packages can further include the Skills 02, 10, 13, 20, 22, and/or 23. In certain embodiments, Pass Protection can include the Skills Bob, Slide, Combo, 5-Man, 6-Man, and/or 7-Man.

In some embodiments, QB IQ Skill Group comprises the Skills Fronts, Coverages, Gaps, Techniques, Zone Drops. In one embodiment, QB Index can include the Skills Composure, QB IQ, Mobility, Technique and Control, Vision, Quick Release, Accuracy, Arm Strength, and/or Urgency. In certain embodiments, QB Index can further include Leadership, Competitiveness, Poise, and/or Work Efficiency.

In one embodiment, the invention is concerned with a method of facilitating athletic skill development. The method can involve storing in a database a Skill Score for each of a plurality of Skills; determining an Athlete Development Rating (ADR) based at least in part on the Skill Scores; and displaying the ADR and one or more Skill Scores. In some embodiments, the method can further include assigning to each of the plurality of Skills one of a plurality of Skill Groups; storing in the database date data associated with each Skill Score; determining a plurality of Skill Group Scores by adding the Skill Scores of each Skill in a Skill Group; and displaying historical data based at least in part on the stored date data for the ADR, one or more Skill Group Scores, and/or one or more Skill Scores. In certain embodiments, the plurality of Skills Groups comprises Basketball IQ, Passing Accuracy, Dribbling, Shooting Mechanics, Scoring Levels, Passing Footwork, Running Lanes, and Defensive Footwork. In some embodiments, the plurality of Skills Groups comprises Volleyball Development Rating, Volleyball IQ, Serve, Pass Underhand, Overhand/Set, Attack, Block, Dig, and/or Athletic Skills.

The above as well as additional features and advantages of the present invention will become apparent in the following detailed written description.

### BRIEF DESCRIPTION OF THE DRAWINGS

The invention itself will best be understood by reference to the following detailed description of an illustrative embodiment when read in conjunction with the accompanying drawings, wherein:

FIG. 1 is a block diagram of a system that can be used to implement certain embodiments of the invention.

FIG. 2 is a flowchart illustrating a method of calculating and displaying an athlete development rating based upon a plurality of measurements according to one embodiment of the invention.

FIG. 3 is a flowchart illustrating another embodiment of a method of calculating and displaying an athlete development rating.

FIG. 4 is a table illustrating one embodiment of determining a Skill Group Score for Accuracy based on Skill Scores associated with Skills included in the Accuracy Skill Group.

FIG. 5 is a table illustrating one embodiment of determining a Skill Group Score for Arm Strength based on Skill Scores associated with Skills included in the Arm Strength Skill Group.

FIG. 6 is a table illustrating one embodiment of determining a Skill Group Score for Mechanics based on Skill Scores associated with Skills included in the Mechanics Skill Group.

FIG. 7 is a table illustrating one embodiment of determining a Skill Group Score for Run Play Footwork based on Skill Scores associated with Skills included in the Run Play Footwork Skill Group.

FIG. 8 is a table illustrating one embodiment of determining a Skill Group Score for Pass Play Footwork based on Skill Scores associated with Skills included in the Pass Play Footwork Skill Group.

FIG. 9 is a table illustrating one embodiment of determining a Skill Group Score for Routes based on Skill Scores associated with Skills included in the Routes Skill Group.

FIG. 10 is a table illustrating one embodiment of determining a Skill Group Score for Football Personnel Packages based on Skill Scores associated with Skills included in the Football Personnel Packages Skill Group.

FIG. 11 is a table illustrating one embodiment of determining a Skill Group Score for Pass Protection based on Skill Scores associated with Skills included in the Pass Protection Skill Group.

FIG. 12 is a table illustrating one embodiment of determining a Skill Group Score for QB IQ based on Skill Scores associated with Skills included in the QB IQ Skill Group.

FIG. 13 is a table illustrating one embodiment of determining a Skill Group Score for QB Index based on Skill Scores associated with Skills included in the QB Index Skill Group.

FIG. 14 is a table illustrating one embodiment of determining a Skill Group Score for Arm Strength based on a weighted sum of Skill Scores associated with Skills included in the Arm Strength Skill Group.

FIG. 15 is a diagram of an exemplary user interface that can be used according to some embodiments of the invention.

FIG. 16 is a diagram of an exemplary user interface listing athletes that can be used according to some embodiments of the invention.

FIG. 17 is a diagram of an exemplary user interface for adding athletes to a database according to some embodiments of the invention.

FIG. 18 is a diagram of an exemplary user interface for adding input associated with the Accuracy Skill Group according to some embodiments of the invention.

FIG. 19 is a diagram of an exemplary user interface for adding input associated with the Arm Strength Skill Group according to some embodiments of the invention.

FIG. 20 is a diagram of an exemplary user interface for adding input associated with the Mechanics Skill Group according to some embodiments of the invention.

FIG. 21 is a diagram of an exemplary user interface for adding input associated with the Run Play Footwork Skill Group according to some embodiments of the invention.

FIG. 22 is a diagram of an exemplary user interface for adding input associated with the Pass Play Footwork Skill Group according to some embodiments of the invention.

FIG. 23 is a diagram of an exemplary user interface for adding input associated with the Routes Skill Group according to some embodiments of the invention.

FIG. 24 is a diagram of an exemplary user interface for adding input associated with the Football Personnel Packages Skill Group according to some embodiments of the invention.

FIG. 25 is a diagram of an exemplary user interface for adding input associated with the Pass Protection Skill Group according to some embodiments of the invention.

FIG. 26 is a diagram of an exemplary user interface for adding input associated with the QB IQ Skill Group according to some embodiments of the invention.

FIG. 27 is a diagram of an exemplary user interface for adding input associated with the QB Development Rating (QBDR) Skill Group according to some embodiments of the invention.

FIG. 28 is a diagram of an exemplary user interface for adding video associated with an athlete's performance of Skills according to some embodiments of the invention.

FIG. 29 is a diagram of an exemplary user interface for displaying data associated with Skill Groups and/or Skill Scores according to some embodiments of the invention.

FIG. 30 is a continuation of the user interface of FIG. 29.

FIG. 31 is a diagram of an exemplary user interface for displaying Skill Scores associated with QB IQ according to some embodiments of the invention.

FIG. 32 is a diagram of an exemplary user interface for displaying Skill Scores associated with QB Development Rating according to some embodiments of the invention.

FIG. 33 is a diagram of an exemplary user interface for displaying Skill Scores associated with Accuracy according to some embodiments of the invention.

FIG. 34 is a diagram of an exemplary user interface for displaying Skill Scores associated with Arm Strength according to some embodiments of the invention.

FIG. 35 is a diagram of an exemplary user interface for displaying Skill Scores associated with Mechanics according to some embodiments of the invention.

FIG. 36 is a diagram of an exemplary user interface for displaying Skill Scores associated with Run Play Footwork according to some embodiments of the invention.

FIG. 37 is a diagram of an exemplary user interface for displaying Skill Scores associated with Pass Play Footwork according to some embodiments of the invention.

FIG. 38 is a diagram of an exemplary user interface for displaying Skill Scores associated with Routes according to some embodiments of the invention.

FIG. 39 is a diagram of an exemplary user interface for displaying Skill Scores associated with Football Personnel Packages according to some embodiments of the invention.

FIG. 40 is a diagram of an exemplary user interface for displaying Skill Scores associated with Pass Protection according to some embodiments of the invention.

FIG. 41 is a diagram of an exemplary database schema for storing data associated with athletes and Skills and Skill Groups according to some embodiments of the invention.

FIG. 42 is a diagram of an exemplary database schema for storing data associated with the Accuracy Skill Group for multiple athletes according to some embodiments of the invention.

FIG. 43 is a diagram of an exemplary database storing data associated with the Accuracy Skill Group of FIG. 42.

FIG. 44 is a diagram of an exemplary database schema for storing data associated with the Arm Strength Skill Group for multiple athletes according to some embodiments of the invention.

FIG. 45 is a diagram of an exemplary database storing data associated with the Arm Strength Skill Group of FIG. 44.

FIG. 46 is a diagram of an exemplary database schema for storing data associated with the Mechanics Skill Group for multiple athletes according to some embodiments of the invention.

FIG. 47 is a diagram of an exemplary database storing data associated with the Mechanics Skill Group of FIG. 42.

FIG. 48 is a continuation of the exemplary database of FIG. 47.

FIG. 49 is a diagram of an exemplary database schema for storing data associated with the Run Play Footwork Skill Group for multiple athletes according to some embodiments of the invention.

FIG. 50 is a diagram of an exemplary database storing data associated with the Run Play Footwork Skill Group of FIG. 49.

FIG. 51 is a continuation of the exemplary database of FIG. 50.

FIG. 52 is a diagram of an exemplary database schema for storing data associated with the Pass Play Footwork Skill Group for multiple athletes according to some embodiments of the invention.

FIG. 53 is a diagram of an exemplary database storing data associated with the Pass Play Footwork Skill Group of FIG. 52.

FIG. 54 is a diagram of an exemplary database schema for storing data associated with the Routes Skill Group for multiple athletes according to some embodiments of the invention.

FIG. 55 is a diagram of an exemplary database storing data associated with the Routes Group of FIG. 54.

FIG. 56 is a diagram of an exemplary database schema for storing data associated with the Football Personnel Packages Skill Group for multiple athletes according to some embodiments of the invention.

FIG. 57 is a diagram of an exemplary database storing data associated with the Football Personnel Packages Skill Group of FIG. 49.

FIG. 58 is a continuation of the exemplary database of FIG. 57.

FIG. 59 is a diagram of an exemplary database schema for storing data associated with the Pass Protection Skill Group for multiple athletes according to some embodiments of the invention.

FIG. 60 is a diagram of an exemplary database storing data associated with the Pass Protection Skill Group of FIG. 59.

FIG. 61 is a diagram of an exemplary database schema for storing data associated with the QB Index Skill Group for multiple athletes according to some embodiments of the invention.

FIG. 62 is a diagram of an exemplary database storing data associated with the QB Index Skill Group of FIG. 49.

FIG. 63 is a continuation of the exemplary database of FIG. 62.

FIG. 64 is a diagram of an exemplary database schema for storing data associated with the QB IQ Skills Group for multiple athletes according to some embodiments of the invention.

FIG. 65 is a diagram of an exemplary database storing data associated with the QB IQ Skills Group of FIG. 64.

FIG. 66 is a diagram of an exemplary database schema for storing data associated with training video for multiple athletes according to some embodiments of the invention.

FIG. 67 is a diagram of an exemplary database storing the video data of FIG. 66.

FIG. 68 is a diagram of an exemplary database schema for storing data associated with athletes according to some embodiments of the invention.

FIG. 69 is a diagram of an exemplary database for storing the athlete data of FIG. 68.

FIG. 70 is a continuation of the exemplary database of FIG. 69.

FIG. 71 is a diagram of an exemplary database schema for storing data associated with roles according to some embodiments of the invention.

FIG. 72 is a diagram of an exemplary database for storing the role data of FIG. 71.

FIG. 73 is a graphic illustration of an exemplary questionnaire that can be used with certain embodiments of the invention.

FIG. 74 is a graphic illustrating an exemplary Basketball Dashboard that can be used with certain embodiments of the invention.

FIG. 75 is a graphic illustrating an exemplary Basketball Development Rating Skill Group.

FIG. 76 is a graphic illustrating an exemplary Basketball IQ Skill Group.

FIG. 77 is a graphic illustrating an exemplary Passing Accuracy Skill Group.

FIG. 78 is a graphic illustrating an exemplary Dribbling Skill Group.

FIG. 79 is a graphic illustrating an exemplary Shooting Mechanics Skill Group.

FIG. 80 is a graphic illustrating an exemplary Scoring Levels Skill Group.

FIG. 81 is a graphic illustrating an exemplary Passing Footwork Skill Group.

FIG. 82 is a graphic illustrating an exemplary Running Lanes Skill Group.

FIG. 83 is a graphic illustrating an exemplary Defensive Footwork Skill Group.

FIG. 84 is a graphic illustrating an exemplary Basketball Personnel Packages Skill Group.

FIG. 85 is a graphic illustrating an exemplary Volleyball Dashboard that can be used with certain embodiments of the invention.

FIG. 86 is a graphic illustrating an exemplary Volleyball Development Rating Skill Group.

FIG. 86A is a graphic illustrating an exemplary Volleyball IQ Skill Group.

FIG. 87 is a graphic illustrating an exemplary Serve Skill Group.

FIG. 88 is a graphic illustrating an exemplary Pass Underhand Skill Group.

FIG. 89 is a graphic illustrating an exemplary Overhand/Set Skill Group.

FIG. 90 is a graphic illustrating an exemplary Attack Skill Group.

FIG. 91 is a graphic illustrating an exemplary Block Skill Group.

FIG. 92 is a graphic illustrating an exemplary Dig Skill Group.

FIG. 93 is a graphic illustrating an exemplary Athletic Skills Skill Group.

### DETAILED DESCRIPTION OF ILLUSTRATIVE EMBODIMENTS

In the following detailed description of exemplary embodiments of the invention, specific exemplary embodiments in which the invention may be practiced are described in sufficient detail to enable those skilled in the relevant technology to practice the invention, and it is to be understood that other embodiments may be used and that mechanical, electrical and other changes may be made without departing from the spirit or scope of the present invention.

In this disclosure the following terms will be used throughout. A Skill can include any physical behavior or mental trait used in the performance of a sport, training for a sport, or assessing the athletic development of an athlete in a given sport. A Skill Score refers to an assessment (quantitative and/or qualitative) of an athlete's proficiency with regard to a given Skill. A Skill Group refers to a set of one or more Skills. A Skill Group Score refers to a sum or aggregation of Skills Scores associated with the Skills included in a Skill Group; the sum or aggregation, in some embodiments, includes weighted Skill Scores. The Athlete Development Rating (ADR) can be a pre-determined Skill Group and/or a collection of Skills suitably selected depending on the sport and/or the specific objectives of a given skills development program.

In some embodiments, a Skill Score can be based on an assessment by an expert (or group of experts) on a given sport. The expert assessment can be based on various measurement scales (such as a scale of a score from 1 to 10; or a scale from 1 to 5; or a qualitative scale such as “poor”, “below average”, “average”, “above average”, “good”, or “excellent”). An expert assessment can include an automated assessment component that uses, for example, machine vision, machine learning, a computerized expert system, or the like.

Accuracy is a Skill Group associated with an athlete's ability to hit a target. In one embodiment, Accuracy can include the Skills Tennis Balls and/or Tire Throws. Tennis Balls is a skill of throwing a tennis ball at a target. The Skill Score for Tennis Balls is based on the number of times the athlete hits a target out of a predetermined number of attempts. Tire Throws is a skill of throwing a football through the center of a tire. The Skill Score for Tire Throws is based on the number of times the athlete successfully throws the football through the center of the tire out of a predetermined number of attempts.

Arm Strength is a Skill Group associated with assessing an athletes' arm strength. In one embodiment, Arm Strength can include the Skills Ball Velocity, Sitting Throws Distance, and/or Longball Standing. In one embodiment, Ball Velocity is an athlete's skill of maximizing the velocity imparted to a tennis ball in a throw. The Skill Score for Ball Velocity can be based on a measurement of the velocity of the ball that an athlete throws; the Skill Score for Ball Velocity can depend on, for example, the velocity of the ball in integer increments of miles per hour. The velocity of the ball can be measured using, for example, a radar gun. The Skill Sitting Throws Distance is a skill of maximizing the distance traveled by an athlete's throw from a sitting position; the Skill Score for Sitting Throws Distance can be based on measuring the distance traveled by the ball. In one embodiment, the distance is measured in yard increments. The Skill Longball Standing is a skill of maximizing the distance traveled by an athlete's throw from a standing position; the Skill Score for Longball Standing can be based on a distance traveled by the ball. In one embodiment, the distance is measured in yard increments.

Mechanics is a Skill Group associated with assessing the proficiency of properly engaging in body motions and/or using body part positions during execution of movements associated with a sport. In one embodiment, Mechanics can include the Skills Stance/Knee Bend, Ball-on-the-Shelf (BOS), Load Efficiency, Alley, Weight Transfer, Follow Through, Shoulder-to-Shoulder, 3-Seconds, and/or Spin Integrity. Stance/Knee Bend refers to the position of an athlete's feet in a throwing stance, along with a slight inflection of the knee; the Skill Score for Stance/Knee Bend can be based on an expert assessment of the proper execution of the position of the feet and the inflection of the knee. BOS refers to properly holding a ball above the breast plate before the athlete throws the ball; the Skill Score for BOS can be based on an expert assessment of the proper positioning of the ball. Load Efficiency refers to movement the athlete uses to load the ball into a throwing position from the BOS position; the Skill Score for Load Efficiency can be based on an expert assessment of the proper execution of the movement. Alley refers to the movement an athlete uses to move the throwing elbow forward into a throw as the athlete's movement transitions from a load position to throwing the ball; the Skill Score for Alley can be based on an expert assessment of the proper positioning of the ball.

Weight Transfer refers to the athlete distributing the athlete's weight to a back foot in the throwing stance during the Load phase and then transferring the weight to a front foot while moving into the Alley phase; the Skill Score for Weight Transfer can be based on an expert assessment of the proper transferring of the athlete's weight. Follow Through refers to movement an athlete uses after throwing a ball, where the throwing elbow and arm fall downward completely toward the opposite thigh; the Skill Score for Follow Through can be based on an expert assessment of the proper elbow and arm movement. Shoulder-to-Shoulder refers to the movement an athlete uses to aim the lead shoulder at a target and end with the throwing shoulder aimed at the target after the BOS, Load, Alley, and Follow Through phases are completed; the Skill Score for Shoulder-to-Shoulder can be based on an expert assessment of the proper shoulder movement. 3-Seconds refers to an athlete's ability to hold the Stance and Follow Through positions after full completion of a throw; the Skill Score for 3-Seconds can be based on an expert assessment of an athlete's balance and body control. Spine Integrity refers to an athlete's ability to hold their body position in an upright position throughout a throw without leaning left or right. The Skill Score for Spine Integrity can be based on an expert assessment of the athlete's ability to hold the spine in position.

Run Play Footwork is a Skill Group associated with an assessment of the knowledge and execution of proper body movements and ball position for run play in football. In one embodiment, Run Play Footwork can include the Skills Seat-the-Ball, A-Gap Right/Left, Reverse Pivot A-Gap Right/Left, Off Tackle Right/Left, Reverse Pivot Off Tackle Right/Left, Toss Sweep Right/Left, Toss Boot Opposite, Option Pitch, Option Read, Inside Zone, Outside Zone, and/or Play Action. Seat-the-Ball refers to the movement an athlete uses to pull the ball close to the mid-section of the body after receiving the ball from an offensive center; the Skill Score for Seat-the-Ball can be based on an expert assessment of the proper ball pulling movement. A-Gap Right/Left refers to the movement an athlete uses to receive the ball from an offensive center, turning to the right or left of the center, and handing the ball to a runner between the offensive center and the guard players at a depth that allows for the runner to receive the ball and run in a desired direction.

Reverse Pivot A-Gap Right/Left refers to the movement an athlete uses to receive the ball from an offensive center, reverse pivoting to the right or left of the center, and handing the ball to a runner between the offensive center and the guard players at a depth allowing for the runner to receive the ball and run in a desired direction. Off Tackle Right/Left refers to the movement an athlete uses to receive the ball from an offensive center, turning to the right or left of the center, and handing the ball to a runner between the offensive guard and the tackle players at a depth allowing for the runner to receive the ball and run in a desired direction.

Reverse Pivot Off Tackle Right/Left refers to a movement an athlete uses to receive the ball from an offensive center, reverse pivoting to the right or left of the offensive center and handing the ball to a runner between the offensive guard and the tackle players at a depth allowing for the runner to receive the ball and run in a desired direction. Toss Sweep Right/Left refers to the movement an athlete uses to receive the ball from an offensive center, reverse pivot to the right or left of the offensive center, and pitch the ball to the runner at a depth allowing for the runner to receive the ball and run in a desired direction. Toss Boot Opposite refers to a movement an athlete uses to receive the ball from an offensive center, reverse pivot to the right or left of the offensive center, fake a pitch to the runner, reverse direction to run with the ball in the opposite direction, and take a throwing stance on the opposite side of the offensive center at a depth for throwing.

Option Pitch refers to a movement an athlete uses to pitch a ball to a runner by pronating the thumb on the pitching hand downward; the Skill Score for Option Pitch can be based on an expert assessment of the proper movement of the hand and thumb by the athlete. Option Read refers to a process an athlete uses to identify the threat of a defensive tackler and to deliver a pitch to a runner using Option Pitch; the Skill Score for Option Read can be based on an expert assessment of the athlete's proper identification of the threat and pitch delivery.

Inside Zone refers to movement an athlete uses while in the Shotgun position to hand a ball to a runner to allow the runner to run between the tackle players. Outside Zone refers to a movement an athlete uses while in the Shotgun position to hand a ball to a runner to allow the runner to run inside or outside of the tackle players. Play Action refers to the movement an athlete uses to turn to fake a hand-off to a runner by extending the ball, pulling the ball back to the Seat-The-Ball position, and setting up to deliver a throw.

The respective Skill Scores for A-Gap Right/Left, Reverse Pivot A-Gap Right/Left, Off Tackle Right/Left, Reverse Pivot Off Tackle Right/Left, Toss Sweep Right/Left, Toss Boot Opposite, Inside Zone, Outside Zone, and Play Action can be based on an expert assessment of the athlete's proper body movement, ball handling, and spatial/timing execution by the athlete.

Pass Play Footwork is a Skill Group associated with assessment of the knowledge and execution of proper body movements and ball position for pass play in football. In one embodiment, Pass Play Footwork can include the Skills 1-Step Drop, 3-Step Drop, 5-Step Drop, Sprint, Screens, and/or RPO PF. 1-Step Drop, 3-Step Drop, and 5-Step Drop refer to the movement an athlete uses to drop back to pass, to set up into a throwing position, using one step, three steps, and five steps, respectively. Sprint refers to the movement an athlete uses to rollout of the pocket to throw the ball on the run to a receiver. The Skill Score respectively for 1-Step Drop, 3-Step Drop, 5-Step Drop, and Sprint can be based on an expert assessment of the athlete's proper body movement.

Screens refers to the movement an athlete uses to drop back to pass while enticing defensive players forward, then passing the ball to a nearby player who is behind said defensive players. Run-Pass-Option Play Fake (RPO PF) refers to the movement an athlete uses from the Shotgun position to fake a hand-off to a runner and then deliver a pass to a receiver. The Skill Score respectively for Screens and RPO PF can be based on an expert assessment of the proper body movement, ball handling, and spatial/timing execution by the athlete.

Routes is a Skill Group associated with an assessment of the execution of throwing various passing routes from a standard football passing tree. In one embodiment, Routes can include Skills Slant, Flat, Comeback, Curl, Dig, Corner, Post, and/or Go. The Skill Score for each of the Skills associated with Routes can be based on an expert assessment of the proper body movement, ball handling, and spatial/timing execution by the athlete.

Football Personnel Packages is a Skill Group associated with an assessment of understanding the standard offensive personnel groupings. In one embodiment, Football Personnel Packages can include 00, 01, 02, 10, 11, 12, 13, 20, 21, 22, and/or 23. In certain embodiments, offensive personnel packages can be denoted by two-digit numbers that identify the type of offensive personnel groupings and the number of each type of player. In one embodiment, the inventive method can include Football Personnel Packages defined as follows. 00 refers to 0 running backs, 0 tight ends, and 5 wide receivers. 01 refers to 0 running backs, 1 tight end, and 4 wide receivers. 02 refers to 0 running backs, 2 tight ends, and 3 wide receivers. 10 refers to 1 running back, 0 tight ends, and 4 wide receivers. 11 refers to 1 running back, 1 tight end, and 3 wide receivers. 12 refers to 1 running back, 2 tight ends, and 2 wide receivers. 13 refers to 1 running back, 3 tight ends, and 1 wide receiver. 20 refers to 2 running backs, 0 tight ends, and 3 wide receivers. 21 refers to 2 running backs, 1 tight end, and 2 wide receivers. 22 refers to 2 running backs, 2 tight ends, and 1 wide receiver. 23 refers to 2 running backs, 3 tight ends, and 0 wide receivers.

Pass Protection is a Skill Group associated with an athlete's understanding of the standard offensive pass protection schemes. In one embodiment, Pass Protection can include schemes Bob, Slide, Combo, 5-Man, 6-Man, and 7-Man. Bob refers to man-on-man blocking by each offensive lineman. Slide refers to each offensive lineman blocking a zone area to their right or left. Combo refers to a combination blocking scheme where half of the offensive linemen block using the Bob scheme and the other half uses the Slide scheme to block zone areas. 5-Man refers to five offensive linemen blocking the defensive lineman and linebackers. 6-Man—refers to five offensive linemen and the running back blocking the defensive lineman and linebackers. 7-Man refers to five offensive linemen, the running back, and a tight end blocking the defensive lineman and linebackers.

QB IQ is a Skill Group associated with an athlete's understanding of defensive personnel groupings and positions. In one embodiment, QB IQ includes the Skills Fronts, Coverages, Gaps, Techniques, and/or Zone Drops. Fronts refers to alignments of defensive linemen. Coverages refers to alignment and responsibilities of defensive secondary players. Gaps refers to spaces between offensive linemen. Techniques refers to a numbering system identifying defensive linemen alignment in front of offensive linemen (for example, a “0” technique is lined up, head up, in front of the center). Zone Drops refers to an area a defender covers within a particular defense.

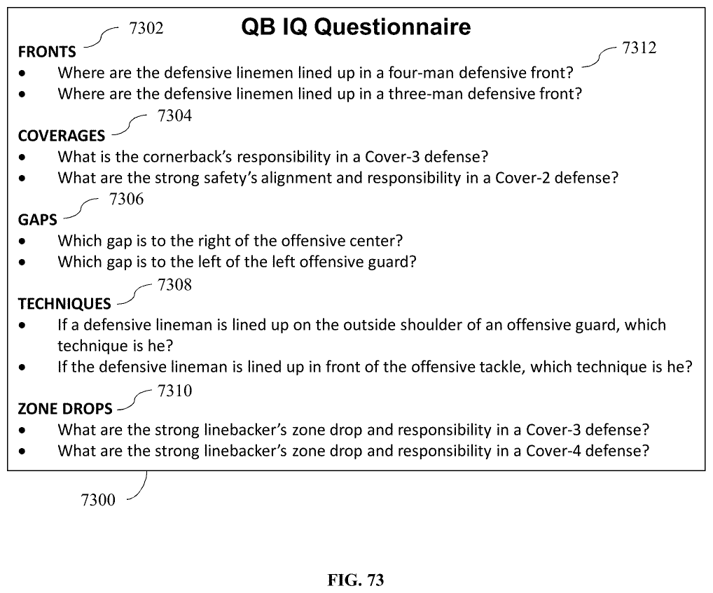

The Skill Score for each of the Skills associated with Football Personnel Packages, Pass Protection, and QB IQ can be based on an athlete's performance on respective questionnaires. By way of example, referencing FIG. 73, QB IQ Questionnaire 7300 can be used to obtain Skills Scores for Skills Fronts 7302, Coverages 7304, Gaps 7306, Techniques 7308, and/or Zone Drops 7310. Each of said Skill Scores can be based on one or more questionnaire questions 7312. Similar questionnaires can be suitably used for assessing any defined Skill for any sport (for example, basketball, baseball, and the like).

QB Development Rating (QBDR) is a Skill Group associated with an assessment of an athlete's proficiency as a football quarterback. In some embodiments, QBDR can be a composite score based on a set of selected Skill Scores and/or Skill Group Scores. In one embodiment, QBDR can include Skills and/or Skill Groups such as Composure, Leadership, QB IQ, Competitiveness, Mobility, Technique and Control, Poise, Vision, Quick Release, Accuracy, Arm Strength, Urgency, and/or Work Efficiency.

Composure refers to an athlete's ability to perform athletically and with a high level of skill while under duress, conflict. and/or fatigue. Leadership refers to, for example, an athlete's work ethic and ability to inspire others to compete and improve skills; an athlete's ability to communicate effectively with trainers and teammates; and an athlete's ability to interact well with trainers and teammates; the Skill Score for Leadership can be based on an expert assessment of leadership abilities during a training session. Competitiveness refers to an athlete's desire to excel in competition and to achieve a goal against a standard (such as a generic QBDR scale, for example) and/or the ADR of athletes. Mobility refers to an athlete's ability to move athletically.

Technique and Control refers to an athlete's use of technique and control in performing a throw. Poise refers to an athlete's trait of associated with being balanced, calm, and/or confident in stressful situations; an assessment of Poise can be obtained by, for example, applying stress through various athletic conditioning and mental drills. Vision refers to an athlete's ability to Vision can be associated with an athlete's ability to, for example, anticipate when to throw, shoot, and/or otherwise release a ball during a throw towards a moving target (such as a catcher, receiver, or the like); the Skill Score for Vision can be based on an expert assessment of an athlete's ability to scan the field of play and anticipate when and where a receiver will be open. Quick Release refers to an athlete's performance in quickly releasing the ball from the time of BOS to Alley; the Skill Score for Quick Release can be based on timing the movement. Urgency refers to an athlete's ability to raise their pace of play while maintaining control and efficient execution of a skill. Work Efficiency refers to an athlete's efficiency in movement and throwing with minimum wasted motion.

The Skill Score for respectively Competitiveness, Mobility, Technique and Control, Poise, Vision, and Work Efficiency can be based on an expert assessment of the athlete's exhibition of relevant physical movements and/or mental traits during a training session and/or in a performance on, for example, a relevant questionnaire.

Basketball Development Rating is a Skill Group associated with an assessment of an athlete's proficiency as a basketball player. In some embodiments, Basketball Development rating can be a composite score based on a set of selected Skill Scores and/or Skill Group Scores. In one embodiment, Basketball Development Rating can include Skills and/or Skill Groups such as Basketball IQ, Composure, Competitiveness, Mobility, Control, Urgency, Poise, Vision, Anticipation, Work Efficiency, Accuracy, and/or Basketball Skills.

Basketball IQ is a Skill Group associated with an assessment of an athlete's ability to predict and adapt to a game or drill in progress based on the athlete's holistic understanding of basketball. Basketball IQ can include Skills such as Dribbling, Shooting, Passing, Techniques, Zone Reads, Trapping Defense, Half Court Offense, Half Court Defense.

Dribbling refers to bouncing the ball repeatedly without interruption. Shooting refers to throwing or tossing the ball towards the basket. Passing refers to an intentional transfer of the ball from one player to another on the same team. Techniques refers to the skill level a player uses to perform a basketball skill like Passing, Shooting or playing defense.

Zone Reads refers to a player's ability to anticipate where an opening will or will not be in a zone defense. Trapping Defense refers to player's understanding and execution of how to play trapping defense when two players defend an offensive player. Half Court Offense refers to a player's understanding and execution of offensive strategy that is executed once the ball is in the opponent's half of the court. Half Court Defense refers to player's understanding and execution of defensive strategy that is executed once the ball is in one's half of the court.

Passing Accuracy is a Skill Group associated with an assessment of an athlete's ability to transfer the ball to a player on the same team from a distance with accuracy. Passing Accuracy can include Skills such as 2 Hand Chest and Bounce Pass and/or 1 Hand Chest and Bounce Pass.

2 Hand Chest and Bounce Pass refers to a player transferring the ball to another player on the same team using a two-handed passing method. 1 Hand Chest and Bounce Pass refers to a player transferring the ball to another player on the same team using a one-handed passing method.

Dribbling is a Skill Group associated with an assessment of an athlete's ability to control the ball by bouncing the ball repeatedly without interruption. Dribbling can include Skills such as Right hand, Left hand, Behind the back, Between the legs, Front Crossover, Spider Dribble, and/or In-and-Out Right/Left.

Right hand refers to a player's ability to dribble with their right hand consistently and repetitively without interruption. Left hand refers to a player's ability to dribble with their left hand consistently and repetitively without interruption. Behind the back refers to a player's ability to dribble behind their back transferring the ball from one hand to another consistently and repetitively without interruption. Between the legs refers to a player's ability to dribble between their legs in a staggered position transferring the ball from one hand to another consistently and repetitively without interruption.

Front Crossover refers to player's ability to dribble from one side to another in front of their body transferring the ball from one hand to another consistently and repetitively without interruption. Spider Dribble refers to a player's ability to stand with their legs spread apart, drop the ball in front of them, and repeatedly: hit the ball with one hand and then the opposite hand, then reach behind and hit it with one hand and then the opposite hand. In-and-Out Right/Left refers to a player's ability to dribble with one hand will moving the ball across their body in front and then back to the same side using one hand.

Shooting Mechanics is a Skill Group associated with an assessment of an athlete's ability to shoot efficiently. Shooting Mechanics can include Skills such as Shooting Stance, Shooting Form, Elbow Placement, Release Point, and/or Follow Through.

Shooting Stance refers to a player's stance while shooting, and includes having balance and a slight bend at the knee. Shooting Form refers to a player's ability to hold the ball and raises it upward to position the ball to be released towards the basket. Elbow Placement refers to a player's ability to maintain their elbow sitting in an “L” position while shooting. Release Point refers to a player's ability to release the ball with a high arc by having a high release point (that is, elbow above the eyes). Follow Through refers to a player's ability to have a fully extended arm held in place after the player shoots.

Scoring Levels is a Skill Group associated with an assessment of an athlete's ability to score baskets from various positions and depths on the court. Scoring Levels can include Skills such as Layups, 15-ft Range, Free Throws, and/or 3-Pointers.

Layups refers to an athlete's skill in executing a two-point a shot where the player leaps from below the basket and lays up the ball near the basket using one hand. 15-ft Range refers to a player's ability in executing a shot towards the basket from a distance of 15 feet. Free Throws refers to a player's ability in executing a shot unopposed from behind the free throw line. 3-Pointers refers to player's ability to shoots the ball towards the basket from behind the three-point line as designated on a basketball court.

Passing Footwork is a Skill Group associated with an assessment of an athlete's ability to use efficient footwork to transfer the ball to another player on the same team. Passing Footwork can include Skills such as Pick and Roll, Pick and Pop, 1 Hand Pocket Pass, 2 Hand Pocket Pass, 1 Hand Bounce Pass, 2 Hand Bounce Pass, and/or Retreating Out Of Trap.

Pick and Roll refers to a player's ability to set a screen for another teammate handling the ball and then moving towards the basket to receive a pass. Pick and Pop refers to a player's ability to set a screen for another teammate handling the ball and then moving to an open area to receive a pass. 1 Hand Pocket Pass refers to a player's ability to pass the ball through a narrow gap between players using one hand. 2 Hand Pocket Pass refers to a player's ability to pass the ball through a narrow gap between players using two hands. 1 Hand Bounce Pass refers to a player's ability to transfer the ball to a teammate using one hand to bounce the ball. 2 Hand Bounce Pass refers to a player's ability transferring the ball to a teammate using two hands to bounce the ball. Retreating Out Of Trap refers to a player's ability as an offensive player, when defended by two players, to retreat to create distance while dribbling with one hand.

Running Lanes is a Skill Group associated with an assessment of an athlete's ability to run the length of the court creating space while a teammate simultaneously dribbles up the court while running. Running Lanes can include Skills such as Fast Break From Both Wings, Down The Middle, Baseline To Baseline, and/or Foot Quickness Drills On Wood.

Fast Break From Both Wings refers to a player's ability to dribble up one side of the court full speed and score. Down The Middle refers to a player's ability to dribble up the middle of the court full speed and score. Baseline To Baseline refers to a player's ability to dribble up the court from one baseline to the opposite end while running full speed.

Defensive Footwork is a Skill Group associated with an assessment of an athlete's ability to efficiently use footwork to position their body and hands in effective defensive positions. Defensive Footwork can include Skills such as Defensive Stance, Hand Up On Shot, Hand In Passing Lane, Cut Off Baseline, Lateral Movement, Denying Passing Lanes, Force Baseline, Defensive Positioning On Ball, and/or Side and Away From Ball Side.

Defensive Stance refers to a player's ability to bend the knees, keep hips low, and chest up to see the offensive player. Hand Up On Shot refers to a player's ability to be in a defensive position while having one hand forward to disrupt the offensive players vision and to influence the direction in which the offensive player can move. Hand In Passing Lane refers to player's ability to be in a defensive position while having one hand in the pathway to where the offensive player wants to pass the ball to another teammate.

Cut Off Baseline refers to a defensive player's ability to deny the offensive player a clear path to dribble down the baseline. Lateral Movement refers to a player's ability to move laterally with athleticism and quickness. Denying Passing Lanes refers to player's ability to be in a defensive position while having one hand in the pathway to where the offensive player wants to pass the ball to another teammate. Force Baseline refers to an athlete's ability to forcing an offensive player who is dribbling to dribble towards the baseline, while denying the offensive player penetration to the middle of the court.

Basketball Personnel Packages is a Skill Group associated with an assessment of an athlete's knowledge, understanding and execution of basketball offenses, defenses and play sets. Basketball Personnel Packages can include Skills such as Man 2 Man, 2-3, 2-1-2, 1-2-2, 1-3-1, Box & 1, High Post, Low Post, Wing, and/or Elbow.

Man 2 Man refers to a player's ability to defend against an offensive player as their sole defensive assignment. 2-3 refers to a player's ability to defend within a defensive formation where two players are positioned near the top of the formation and three players are positioned in the underneath position. 2-1-2 refers to a player's ability to defend within a defensive formation where two players are positioned near the top of the formation, one player is positioned in the mid-position and two players are positioned in the underneath position.

1-2-2 refers to a player's ability to defend within a defensive formation where one player is positioned near the top of the formation, two players are positioned in the mid-position, and two players are positioned in the underneath position. 1-3-1 refers to a player's ability to defend within a defensive formation where one player is positioned near the top of the formation, three players are positioned in the mid-position and one player is positioned in the underneath position.

Box & 1 refers to a player's ability to defend within a defensive formation where one defensive player uses man-to-man defense on one player and the other four defensive players use zone defense.

Volleyball Development Rating is a Skill Group associated with an assessment of an athlete's proficiency as a volleyball player. Volleyball Development Rating can include Skills such as Volleyball IQ, Composure, Competitiveness, Mobility, Volleyball Technique & Control, Poise, Vision, Attack, Work Efficiency, Volleyball Accuracy, Power, and/or Urgency. Volleyball Technique & Control refers to an athlete's ability to use proper volleyball technique and body control to execute volleyball skills including, for example, hitting, setting, blocking and digging. Volleyball Accuracy refers to an athlete's ability to place the ball at a specific location on the volleyball court or transfer the ball to another player by either hitting or setting the ball. Volleyball IQ is a Skill Group associated with an assessment of an athlete's ability to predict and adapt to a game or drill in progress based on the athlete's understanding of the overall game of volleyball. Volleyball IQ can include Skills such as passing, setting, blocking, digging and serving.

Serve is a Skill Group associated with an assessment of an athlete's ability to put the ball in play by hitting the ball over the net into the opposing court. Serve can include Skills such as Toe Point, QB Arm, Toss Away, Step Forward, Big Hand, Elbow High, and/or Follow Through.

Toe Point refers to an athlete's ability to effectively point their toe in the direction of their serve. QB Arm refers to an athlete's ability to hold their serving arm high with the elbow pointing upward and the hand above the ear. Toss Away refers to an athlete's ability to lift the ball in the air with the non-dominant hand and keep the ball lined up with the shoulder and slightly in front of the body. Step Forward refers to an athlete's ability to transfer the weight of the body by stepping forward with the back foot as the player hits the ball with their serving hand. Big Hand refers to an athlete's ability to stretching their hands and fingers wide when blocking or setting the ball. Elbow High refers to an athlete's ability to hold their serving arm high with the elbow pointing upward and the hand above the ear. Follow Through refers to an athlete's ability to follow through with their serving arm and hand from a high position downward as the athlete puts the ball in play or spikes the ball.

Pass Underhand is a Skill Group associated with an assessment of an athlete's ability to put the ball in play by serving using an underhand or upward hand and arm motion. Pass Underhand can include Skills such as Wide Base, Platform Drop, Extension, Target Hip Turn, Platform Out, Freeze, and/or Communicate. Wide Base refers to an athlete's ability to position their feet in a wide stance to provide stability and balance when hitting the volleyball. Platform Drop refers to an athlete's ability to contact and control the volleyball when it drops below the waist by locking the elbows and contacting the ball above the wrists and below the elbows. Extension refers to an athlete's ability to execute a defensive move where the athlete extends to their right or left to make contact with the ball. Target Hip Turn refers to an athlete's ability to keep their upward hip pointed at the aiming point when putting the ball in play by serving overhand. Communicate refers to an athlete's ability to communicate with teammates to avoid confusion and for safety. The Skill Communicate can involve using short words or phrases that are easily heard and understood by teammates, such as “I got it,” “Mine,” or “Me.”

Overhand/Set is a Skill Group associated with an assessment of an athlete's ability to direct the ball to a teammate by hitting the ball with the fingers in an overhead setting motion. Overhand/Set can include Skills such as Under Ball, Right Foot Forward, Hands High, Extension, and/or Communicate. Under Ball refers to an athlete's ability to position their body directly underneath a ball in the air to hit the ball using the fingers in an overhead setting motion. Hands High refers to an athlete's ability to position their hands high overhead after getting in position to direct the ball to a teammate. Extension refers to an athlete's ability to extend the arms at the elbow when following through an overhead setting motion.

Attack is a Skill Group associated with an assessment of an athlete's ability to attack the ball towards the opponent's side of the court in a spike, tip, set or over-the-head contact. Attack can include Skills such as Left-Right-Left Jump and/or Bow & Arrow. Left-Right-Left Jump refers to an athlete's ability to approach the ball for hitting or the net for block using a left-foot, right-foot, left-foot jumping technique. Bow & Arrow refers to an athlete's ability to serve using an overhead technique where the off-hand holds the ball straight out and the hitting hand is positioned near the ear. The server tosses the ball in the air with the off-hand and then hits the ball using an overhead swing of the serving hand.

Block is a Skill Group associated with an assessment of an athlete's ability to position the body to block an opponent's hit ball from crossing the net. Block can include Skills such as Hand High, Legs Flexed, Shuffle, Crossover, Close Block, Hands Penetrate, and/or Communicate.

Hand High refers to an athlete's ability to positioning their hands high overhead when blocking an opponent's hit ball to minimize the space the opponent's hit ball can have to get over the net. Legs Flexed refers to an athlete's ability to be in position prior to the ball being put in play by standing with a slight knee bend while facing the opposing team. Shuffle refers to an athlete's ability to move into position to hit or serve the ball by sliding to either side without crossing the feet. Crossover refers to an athlete's ability to move into position to hit or serve the ball by crossing over the feet. Close Block refers to an athlete's ability to position the body close to a teammate, while the two simultaneously jump to block an attack hit, to limit the seams between them as the two players jump to block. Hands Penetrate refers to an athlete's ability to get their hands onto the other side of the net as far as possible to narrow the angles available to the opponent.

Dig is a Skill Group associated with an assessment of an athlete's ability to keep a hard-driven ball, usually a spike, in play by not letting it hit the floor. Dig can include Skills such as Low Posture, Platform to Target, and/or Floor Skills (for example, Sprawl, Dives, and/or Rolls).

Low Posture refers to an athlete's ability to remain in a low posture stance in order to dig out a ball that is driven low. Platform to Target refers to an athlete's ability to keep their arm and leg platform position while driving low to dig out a hard-driven hit ball. Floor Skills refers to Skills such as Sprawl, Dives, and/or Rolls. Sprawl refers to an athlete's ability to make a defensive hit by sprawling out by leaning forward and lunging to hit the ball. Dives refers to an athlete's ability to make a defensive hit by diving forward and leaving the feet to hit the ball. Rolls refers to an athlete's ability to execute sprawl motion with a roll on the floor after hitting the ball, as a method of protecting their body while on the floor.

Athletic Skills is a Skill Group associated with an assessment of an athlete's ability to perform athletic skills and physical movement used to play Volleyball. Athletic Skills can include Skills such as Broad Jump, Medicine Ball Throw, Vertical Jump, Approach Jump, and/or Block Jump. Broad Jump refers to an athlete's ability to jump the farthest distance possible from a standing start. Medicine Ball Throw refers to an athlete's ability to throw a weighted ball the farthest distance possible from a standing start. Vertical Jump refers to an athlete's ability to jump the highest distance possible from a standing start. Approach Jump refers to an athlete's ability to jump the highest distance possible taking one or more steps to start. Block Jump refers to an athlete's ability to jump the highest distance possible from a standing start and touching a wall at the highest point with both hands.

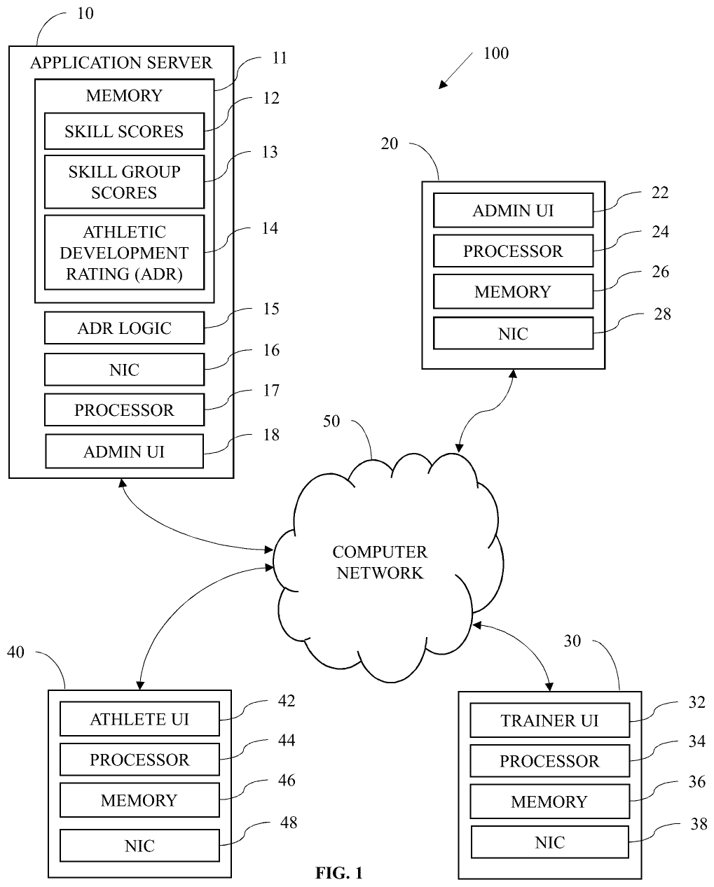

Referencing FIG. 1, computer system 100 can be used to implement athletic development rating methods according to embodiments of the invention described herein. System 100 can include application server 10 in communication with admin device 20, trainer device 30, and/or athlete device 40 via network 50.

Each of application server 10, admin device 20, trainer device 30, and athlete device 40 can be a standalone computer or mobile computing device, mainframe computer system, workstation, network computer, desktop computer, laptop, or the like. Each of application server 10, admin device 20, trainer device 30, and athlete device 40 can include: (A) one or more processors 17, 24, 36, and 44, respectively, coupled to memory 11, 26, 36, and 46; (B) network interface 16, 28, 38, and 48 to communicate via network 50; and (C) one or more input/output (I/O) devices such as video devices, audio devices, and displays in operable communication with processors 17, 24, 36, 44 and memories 11, 26, 36, and 46.

Processors 17, 24, 36, 44 suitable for the execution of a computer programs include both general and special purpose microprocessors and any one or more processors of any digital computing device. For instance, processor 17 can receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

Network interface 16, 28, 38, and 48 may be configured to allow data to be exchanged between application server 10, admin device 20, trainer device 30, and/or athlete device 40 via network 50. In various embodiments, network interface 16, for example, can support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol.

Memory 11 can include Athlete Development Rating (ADR) logic 15 that can be configured to implement certain embodiments described herein. In one embodiment, ADR logic 15 can include computer program modules corresponding to one or more of the various embodiments described herein. For example, ADR logic 15 can be implemented in various embodiments using any desired programming language, scripting language, or combination of programming languages and/or scripting languages (e.g., C, C++, C#, JAVA®, JAVASCRIPT®, PERL®, and the like).

The steps and actions of system 100 described in connection with the embodiments disclosed herein may be embodied directly in hardware, in a program module executed by a processor, or in a combination of the two. A program module may reside in RAM, flash memory, ROM memory, EPROM memory, EEPROM memory, registers, a hard disk, a removable disk, a CD-ROM, or any other form of storage medium known in the art. An exemplary storage medium can be coupled to processor 17, 24, 36, 44 such that said processor can read information from, and write information to, the respective storage medium. In the alternative, the storage medium may be integrated into said processor. Further, in some embodiments, said processor and the storage medium may reside in an Application Specific Integrated Circuit (ASIC). In the alternative, said processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

Also, any connection may be associated with a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc,” as used herein, include compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

In some embodiments, the system is world-wide-web (www) based, and the network server is a web server delivering HTML, XML, etc., web pages to the computer system. In other embodiments, a client-server architecture may be implemented, in which a network server executes enterprise and custom software, exchanging data with custom client applications running on the computing device.

In some embodiments, ADR logic 15 can include computer program modules for facilitating the production of an athlete development rating via the interaction of application server 10, admin device 20, trainer device 30, and/or athlete device 40. ADR logic 15 can include program modules for supporting admin UI 18, admin UI 22, trainer UI 32, and/or athlete UI 42. Admin UI 18 can provide tools for the configuration and provision of, for example, portals for interaction between application server 10, admin device 20, trainer device 30, and/or athlete device 40.

In one embodiment, ADR logic 15 can include program modules for receiving and storing user profiles associated with trainer device 30 and/or athlete device 115. In some embodiments, ADR logic 10 includes program modules for (A) facilitating building and storing a database to store athlete information; (B) store in memory 11 Skill Scores 12; storing date data associated with each Skill Score; (C) assigning a Skill Group to each Skill; (D) determining and storing Skill Group Scores 13 by, (E) at least in part, adding the Skill Scores 12 of each Skill in a Skill Group; (F) selecting one of the Skill Group Scores 13 as an Athlete Development Rating (ADR) 14; (G) displaying ADR 14, one or more Skill Group Scores 13, and/or one or more Skill Scores 12; and/or (H) displaying historical data based at least in part on the stored date data for ADR 14, one or more Skill Group Scores 13, and/or one more Skill Scores 12. In some embodiments, ADR logic 15 can be distributed across application server 10, admin device 20, trainer device 30, and/or athlete device 40.

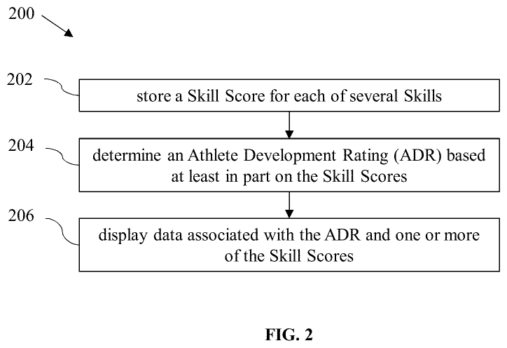

Referencing FIG. 2, in one embodiment a method 200 of tracking and rating an athlete's development can include a step 202 of creating electronic records to store a Skill Score for each several Skills associated with the athlete in a given sport. The exemplary embodiments described here are generally directed to the sport of football; however, the systems and method disclosed here can be also suitably applied to other sports including, for example, basketball, baseball, soccer, track and field, skiing, volleyball, and the like. For sports other than football, Skills and Skill Groups can be selected to include those skills that are generally thought to be necessary and/or important for proficiency in the given sport. For a sport like soccer for example, a Skill Group that can be defined is Passing Play, which would refer generally to the skills necessary of an athlete to be proficient at passing the ball. A Skill that can be included in Passing Play, for example, can be Passing Precision, which can refer to an athlete's effectiveness in being precise with passing the ball so that the ball is passed to the right teammate. A Skill Score for Passing Precision can be based on, for example, a percentage of successful passes relative to pass attempts. For a sport like basketball, similarly to soccer a Passing Play Skill Group can be defined; Passing Play in basketball can similarly include a Skill like Passing Precision.

At a step 204 a computer program module, for example, can be used to determine an Athlete Development Rating (“ADR”) 14 based at least in part on the stored Skill Scores 12. In one embodiment, referencing FIG. 13, ADR 14 can be a QB Index (or also referenced as QB Development Rating (“QBDR”)), which can be a composite score of several Skill Scores 12 and/or Skill Group Scores 13. The QBDR can be based on quantitative and/or qualitative assessments of an athlete's proficiency in Skills (including traits such as Leadership, Competitiveness, and/or Poise, for example). The QBDR can be tracked in real time, and historical records can be stored, to track an athlete's progress and/or development over time.

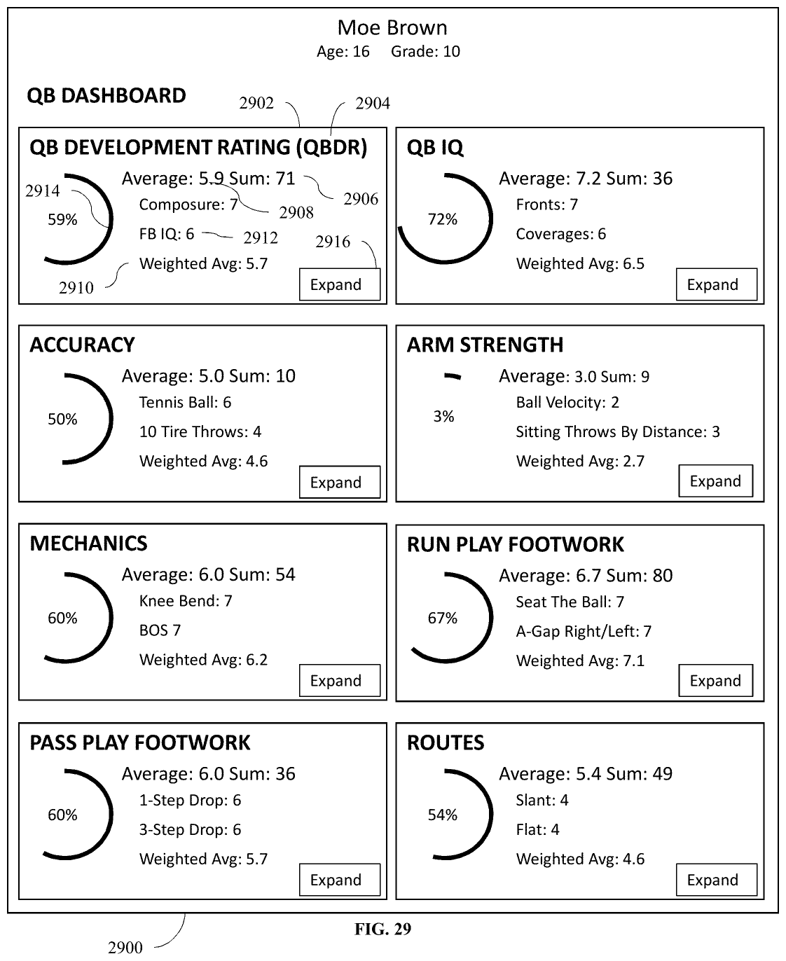

At a step 206, a computer system can be used to display data associated with ADR 14 and/or one more Skill Scores 12. Referencing FIG. 29, a diagram of an exemplary user interface is shown, which user interface can be used to display graphically and numerically the QBDR for a given athlete. In the example shown, the QBDR is 59% for athlete Moe Brown, and several constituent Skill Scores 12 are provided, such as 7 for Composure and 6 for QB IQ. In some embodiments, the user interface of FIG. 29, can be styled as a “Dashboard” presenting data associated with the Skill Groups and Skill Group Scores 13 for a given athlete.

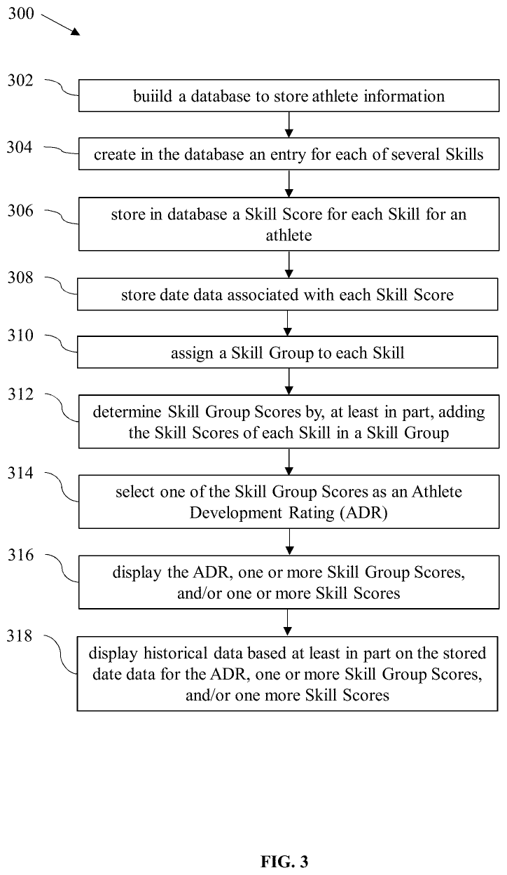

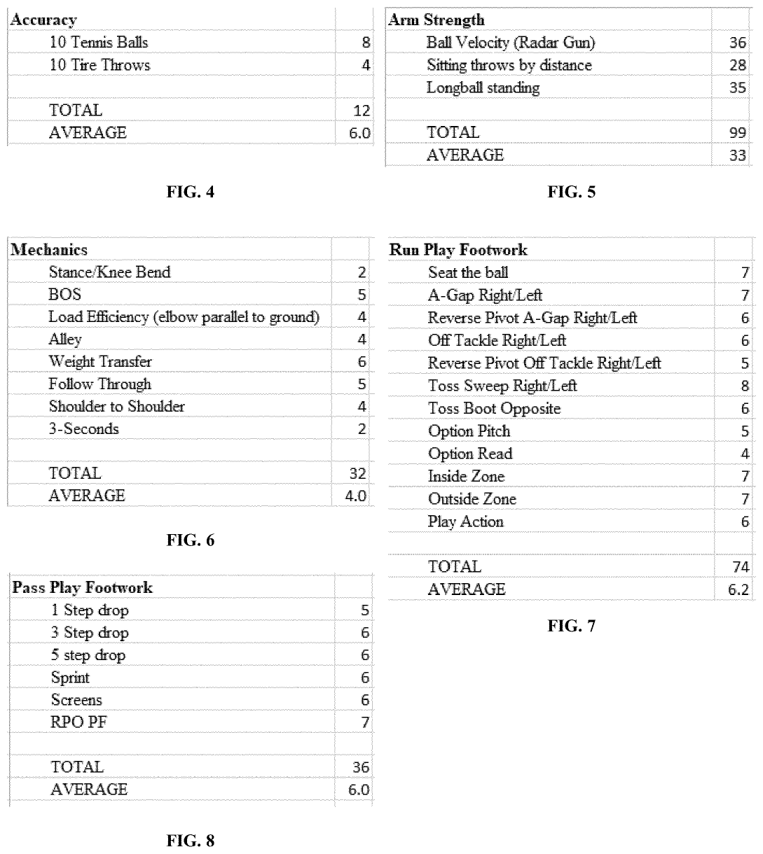

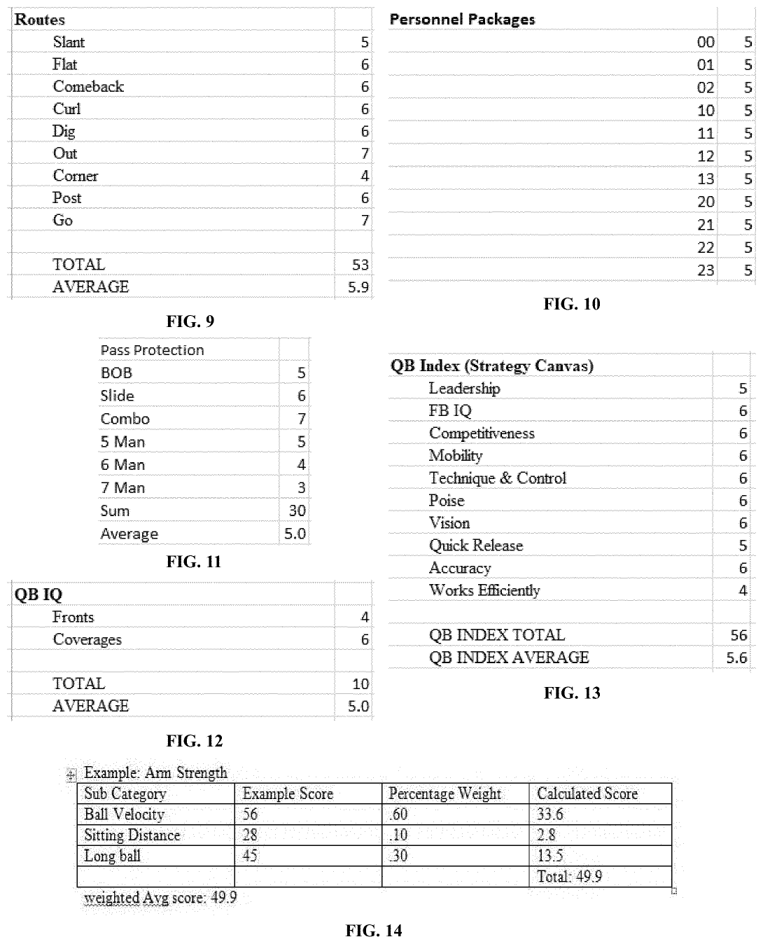

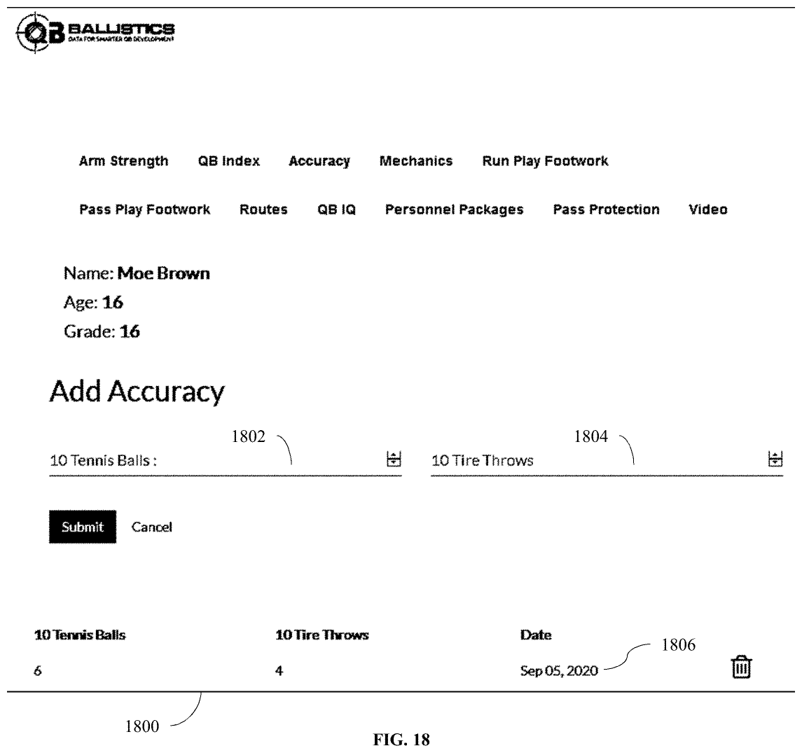

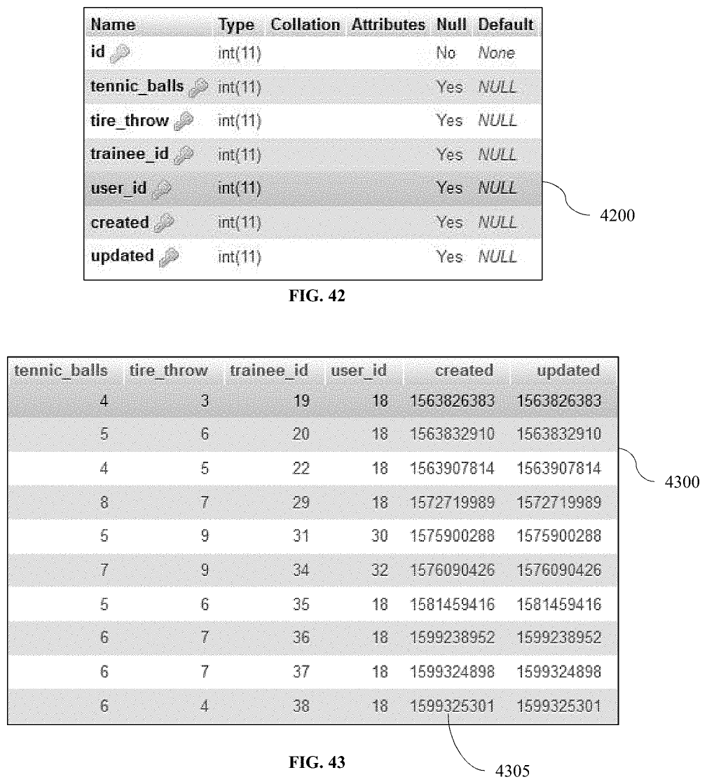

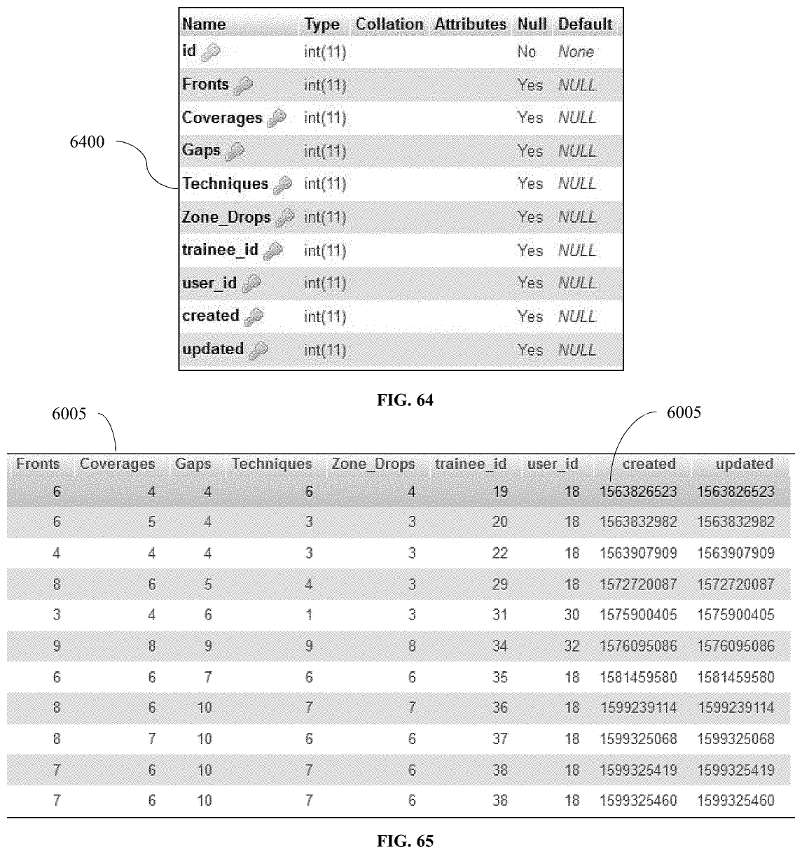

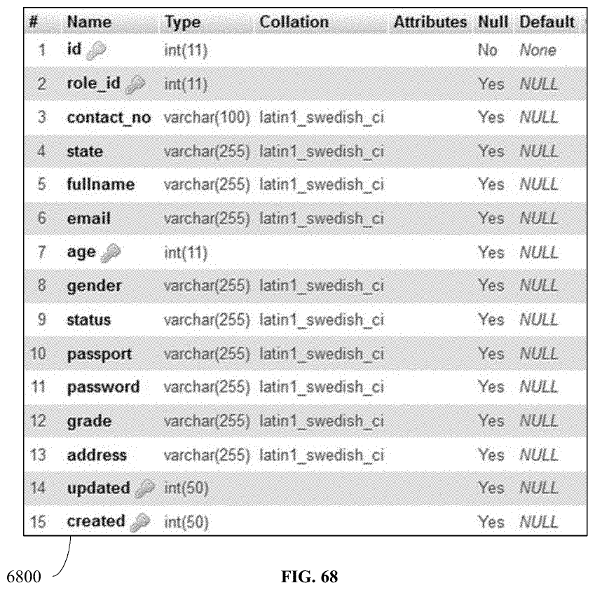

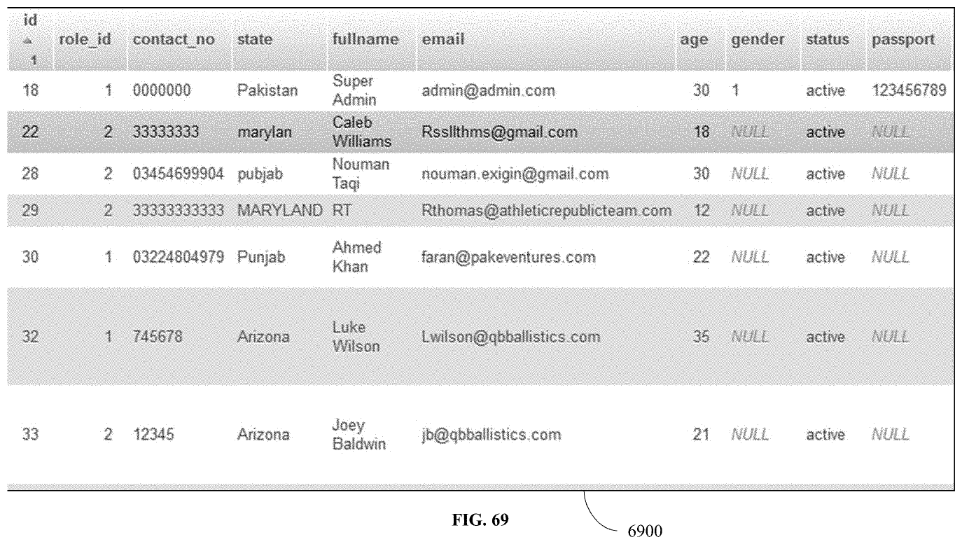

Referencing FIG. 3, yet another embodiment the invention is directed to a method 300 of tracking and rating an athlete's development. The method 300 can include a step 302 of building an electronic database (stored in memory 11, for example) to store information associated with one or more athletes. Referencing FIG. 68 and FIG. 69, in one embodiment athlete information can include, for example, contact number, the residence State, name, email address, age, gender, grade level, address, and the like. At a step 304, an entry in a database can be created for each Skill associated with an athlete and/or an ADR 14. Referencing FIG. 4 through FIG. 13, in one embodiment, ten different Skill Groups can be defined comprising, cumulative, about 69 Skills. At a step 306, a Skill Score 12 can be stored in the database records for each Skill being tracked for each athlete. Referencing FIG. 42 through FIG. 65, electronic database records can be provided with an entry for each Skill and Skill Score 12 to be tracked for one or more athletes. At a step 308, as illustrated in FIG. 18, a user interface can be provided and/or used to store date data associated with the Skill Score 12 for a given Skill. For example, for the athlete “Moe Brown”, for Accuracy the Skill Scores for Tennis Balls and Tire Throws is associated with the date “Sep. 5, 2020”.

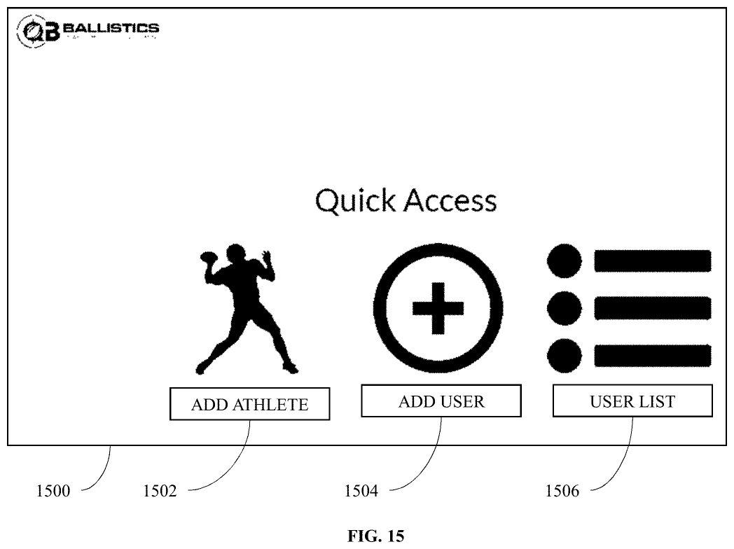

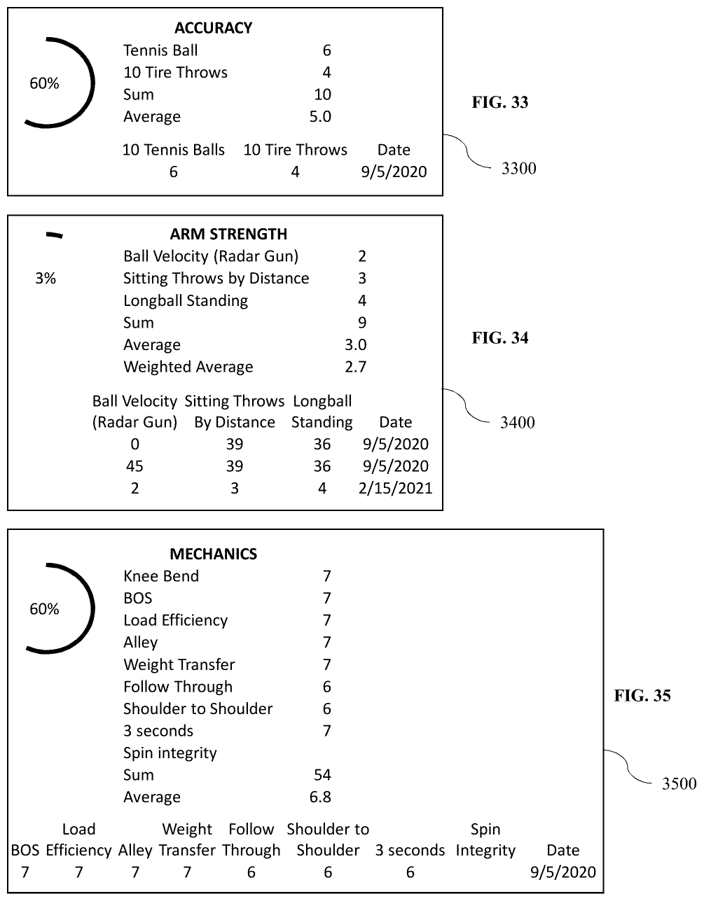

At a step 310, a Skill Group can be assigned to each Skill. It should be noted that step 310 can be done concurrently with step 302 or step 304, or preceding step 304. In one embodiment, each of the Skills is associated with a given Skill Group. For example, the Skills Tennis Throws and Tire Throws can be associated with the Skill Group Accuracy (see FIG. 4, FIG. 42, and FIG. 43, for example). At a step 312, a computer program module (such as ADR Logic 15) can be used to determine Skill Group Scores 13 by, at least in part, adding the Skill Scores 12 of each Skill in a Skill Group. Referencing FIG. 33, for example, in one embodiment a Skill Group Score for Accuracy can be determined by adding the Skill Scores 12 for Tennis Balls and Tire Throws then taking an average (that is, 6+4=10, average=5). Algorithmically, determining a Skill Group Score 13 can involve looping through the Skills for a Skill Group and cumulative adding Skill Scores 12. After a sum of Skill Scores 12 for the Skills in a given Skill Group has been obtained then an average can be calculated and assigned as the Skill Group Score 13. Then the algorithm can loop through the remaining Skill Groups to similarly calculate Skill Group Scores 13 for each of the remaining Skill Groups. In one embodiment, the Skill Group Score 13 can be the sum of the Skill Scores 12. In some embodiments, a Skill Group Score 13 can be calculated based on adding weighted Skill Scores 12 (see FIG. 14); for example, for Arm Strength each of the Skill Scores 12 is multiplied by a “Percentage Weight” to calculate a “Calculated Score”, then these Calculated Scores are added to calculate a weighted average Skill Group Score 13. The Percentage Weights can be selected to suitable scale the raw, measured scores to normalize the data and/or reflect expert judgment of the importance of a given Skill relative to the other Skills in a Skill Group.

At a step 314, a Skill Group Score 13 is selected as ADR 15. In some embodiments, the Skills associated with ADR 15 are selected based on expert judgments of the suitable physical, mental, and personality skills and/or traits that a successful athlete should have to successful at a sport and/or a given position in that sport. It should be noted that step 314 can be performed concurrently with steps 302, 304, and/or 310, or preceding steps 304 and/or 310. In one embodiment, referencing FIG. 13, a set of Skills has been associated with the Skill Group QB Index (also referred to as QB Development Rating (QBDR)), which can be selected as ADR 14. For the specific example of the sport of football, ADR 14 refers to the development rating of an athlete as a football quarterback. In some embodiments, the composite score of ADR 14 can include Skill Scores 12 and/or Skill Group Scores 13; for example, in the QB Index of FIG. 13, the Skill Group Accuracy is included along with other Skills (such as Leadership).

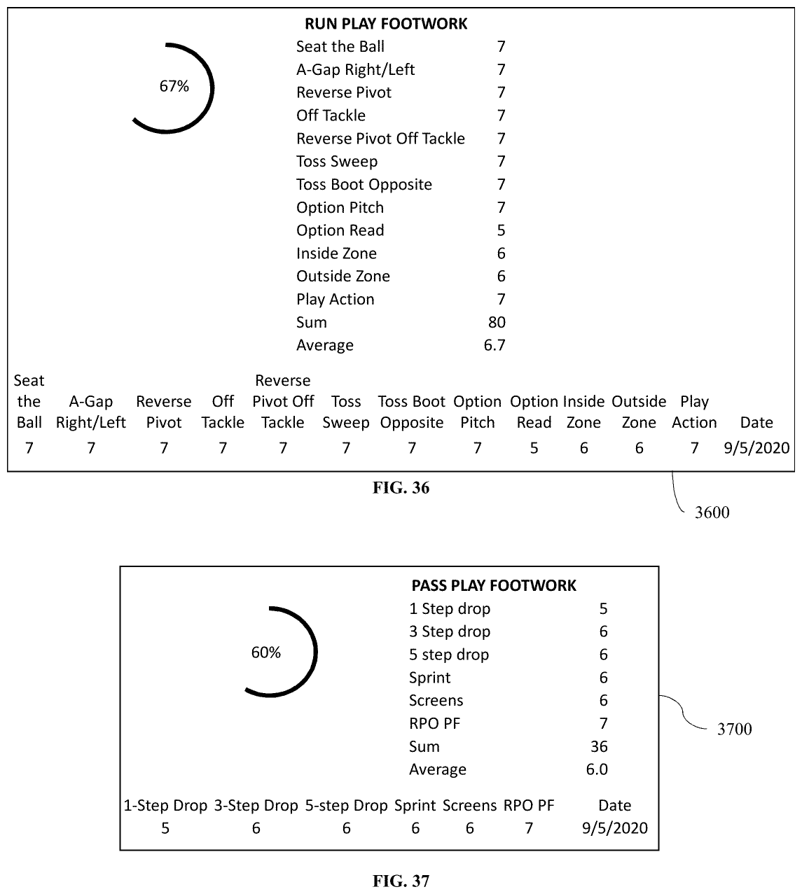

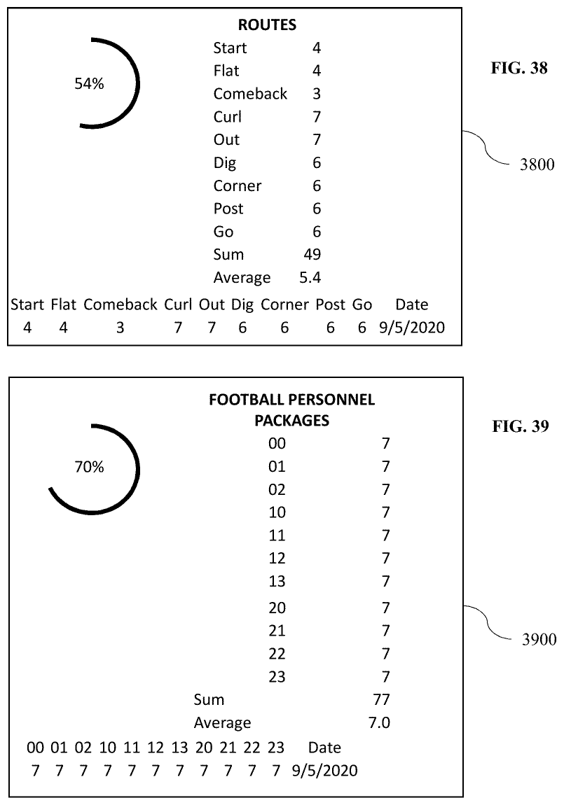

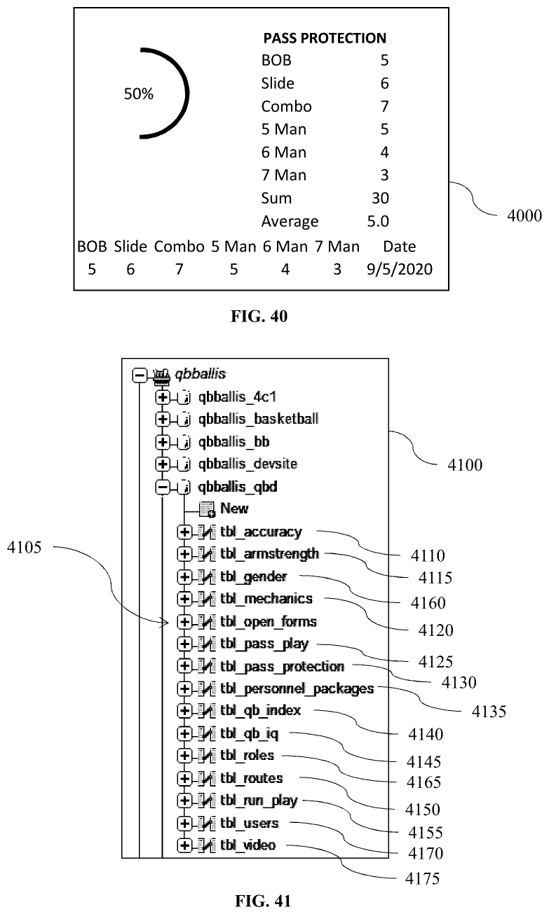

At a step 316, a user interface (for example, admin UI 18, admin UI 22, trainer UI 32, and/or athlete UI 42) can be used to display ADR 14, one or more Skill Group Scores 13, and one or more Skill Scores 12. Referencing FIG. 29 through FIG. 40, diagrams illustrate exemplary user interfaces for displaying ADR 15 (such as the QBDR), Skill Group Scores 13 (such as Accuracy, Arm Strength, and the like), and Skill Scores 12 (such as Composure, Tennis Balls, Ball Velocity, Slant, and the like). In one embodiment, a “Dashboard” can be provided that displays a QBDR (ADR 14) and some of the Skill Scores 12 for the Skills included in the QBDR. The Dashboard can also include display components for other Skills Groups (such as Accuracy, Arm Strength, and the like); the display components can list some of the Skill Scores 12 for the Skills associated with the respective Skill Groups.

At a step 318, trainer interface 32 can be used to display historical data based at least in part on the stored date data for ADR 14, one or more Skill Group Scores 13, and one or more Skill Scores 12. Referencing FIG. 34, a diagram of a user interface 3400 shows the display of historical data for Arm Strength. Each of the Skill Scores 12 stored are associated with a given date (that is, for example, Ball Velocity 45, Sitting Throws 39, and Longball Standing 36 are associated with the date “Sep. 5, 2020”).

Referencing FIG. 4 through FIG. 13, one embodiment of a method and a system for tracking athlete development in the sport of football is described. Referencing FIG. 4, Skills Tennis Balls and Tire Throws are associated with Skill Group Accuracy. In one embodiment, the athlete's performance is evaluated on the basis of 10 throws; however, in other embodiments less or more throws can be used. In the example shown, the athlete successfully hit a target with a tennis ball 8 out of 10 times, and threw a football through the center of a tire 4 out of 10 times. The Skill Group Score raw score is 12 (that is, the sum: 8+4), and the Skill Group Score is 6 (that is the geometric average of 8 and 4). In some embodiments, other Skills associated with assessing Accuracy can be included.

Referencing FIG. 5, Skills Ball Velocity, Sitting Throws Distance, Longball Standing are associated with Skill Group Arm Strength; in other embodiments, other Skills associated with assessing Arm Strength can be included. In one embodiment, the athlete's performance is evaluated on the basis of distance traveled by a thrown ball and the speed of the ball (as measured by, for example, a radar gun). In the example shown, the athlete threw a ball with a velocity of 36 miles per hour, threw a ball 28 yards from a sitting position, and threw a ball 35 yards from a standing position. The Skill Group Score raw score is 99 (that is, the sum: 36+28+35), and the Skill Group Score is 33 (that is, the geometric average of 36, 28, and 35). Referencing FIG. 6, a set of Skills can be associated with the Skill Group Mechanics; in other embodiments, other Skills associated with assessing Mechanics can be included, and some of the Skills included in FIG. 6 can be omitted. In the example shown, Skill Group Score raw score is 32, and the Skill Group Score is 4.

The same general description can be applied to the Skill Groups of FIG. 7 through FIG. 13, namely respectively Skill Groups Run Play Footwork, Pass Play Footwork, Routes, Football Personnel Packages, Pass Protection, QB IQ, and QB Index (QBDR). For each of those Skill Groups, in other embodiments the constituent Skills can include additional Skills and/or omit Skills included in the exemplary embodiment; Skills not specifically mentioned in this description can be added to any of the Skills Groups when desired and the Skills are associated with facilitating the proficiency assessment of the given Skill Group. The Skill Scores can be based on any suitable scale. For example, for the Skill Scores of the Skills associated with Mechanics, Run Play Footwork, Pass Play Footwork, Routes, and Pass Protection, can be based on a 1 to 10 scale. Such Skill Scores can be based on a subjective evaluation by an expert (such as a coach or a trainer). In some embodiments, multiple experts can each assign a Skill Score and an average of those Skill Scores can then be the Skill Score stored for a given Skill. In other embodiments, an automated or semi-automated expert system (such as a machine learning component, for example) can be used to assign Skill Scores to skills performed by an athlete. For some Skill Groups (such as Football Personnel Packages and Routes, for example), Skill Scores can be assigned based on an athlete's performance on a questionnaire.

Referencing FIG. 15, user interface 1500 can be provided for managing data associated with athletes and other users of system 100. In one embodiment, input ADD ATHLETE 1502 can be provided for accessing a user interface for adding athletes to the database; input ADD USER 1504 can be provided for accessing a user interface for adding users (such as trainers, coaches, administrators, and the like) to the database; and input USER LIST 1506 can be provided for accessing a user interface for viewing a list of users.

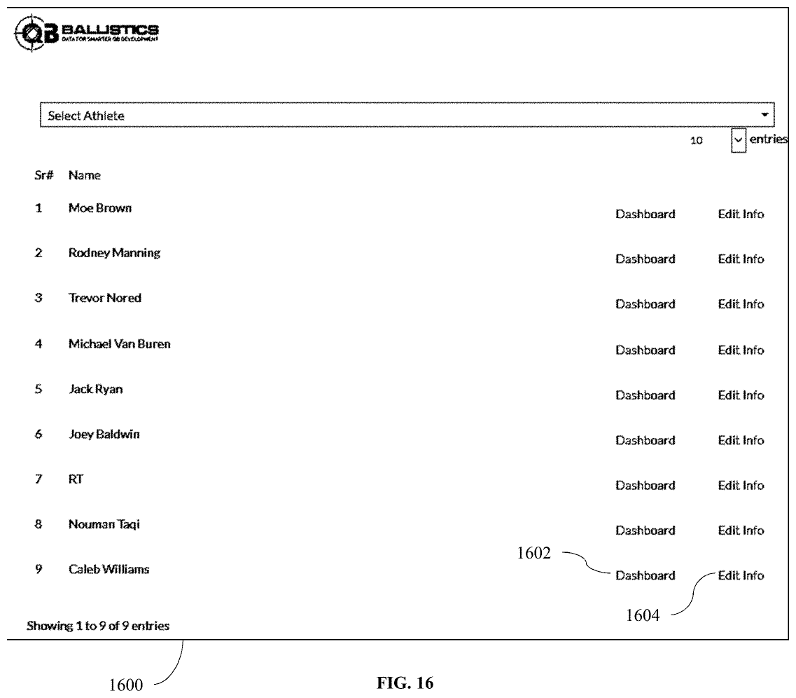

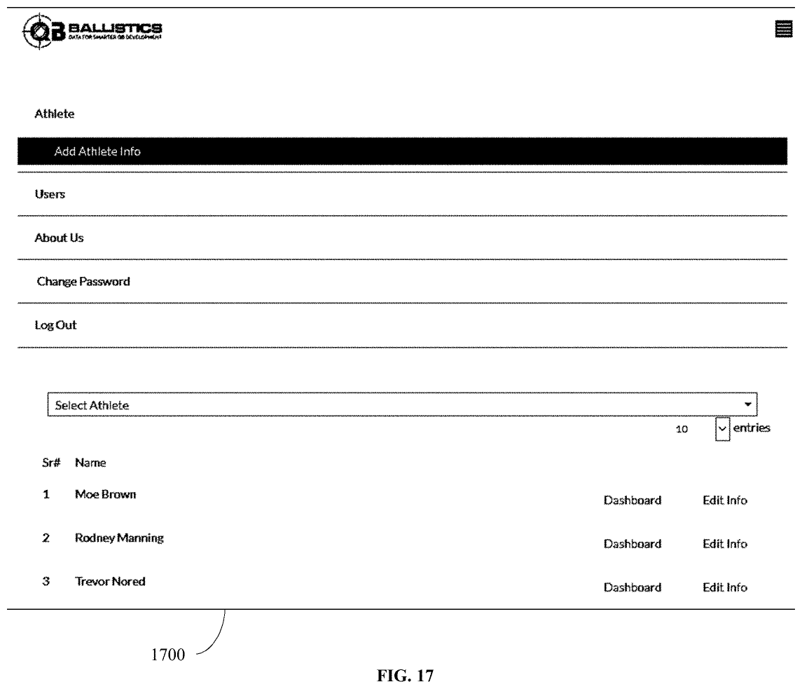

Referencing FIG. 16, user interface 1600 can be provided for displaying and/or selecting a list of athlete records stored in the database. In some embodiments, input Dashboard 1602 and/or input Edit Info 1604 can be provided for, respectively, accessing a dashboard for a given athlete and editing the data associated with the given athlete. Referencing FIG. 17, user interface 1700 can be another user interface for accessing athlete information and/or interacting with system 100.

Referencing FIG. 18, user interface 1800 can be provided to input and/or edit data for the Accuracy Skill Group. Input Tennis Balls 1802 and input Tire Throws 1804 can be provided for, respectively, receiving Skill Scores for the number of successful hits of the target with a tennis balls and the number of successful throws of a ball through the center or a tire. The input data can be received by application server 10 and stored in memory 11 along with date data 1806.

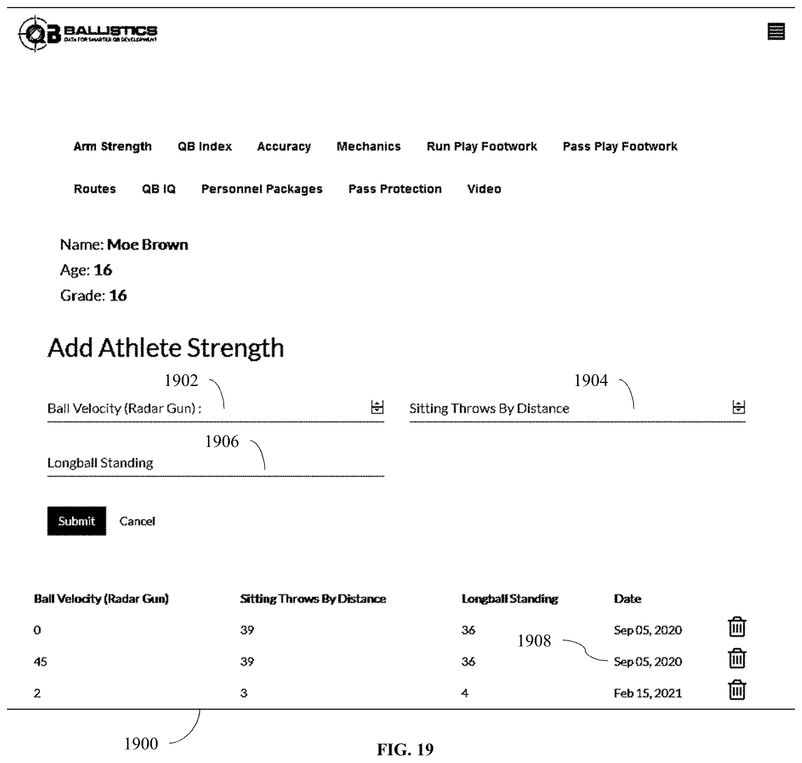

Referencing FIG. 19, user interface 1900 can be provided to input and/or edit data for the Arm Strength Skill Group. Input Ball Velocity 1902, input Sitting Throws 1904, and input Longball Standing 1906 can be provided for, respectively, receiving Skill Scores for the velocity of the ball delivered by the athlete's throw, the distance traveled by the ball thrown from a sitting position, and the distance traveled by the ball thrown from a standing position. The input data can be received by application server 10 and stored in the memory 11 along with date data 1908.

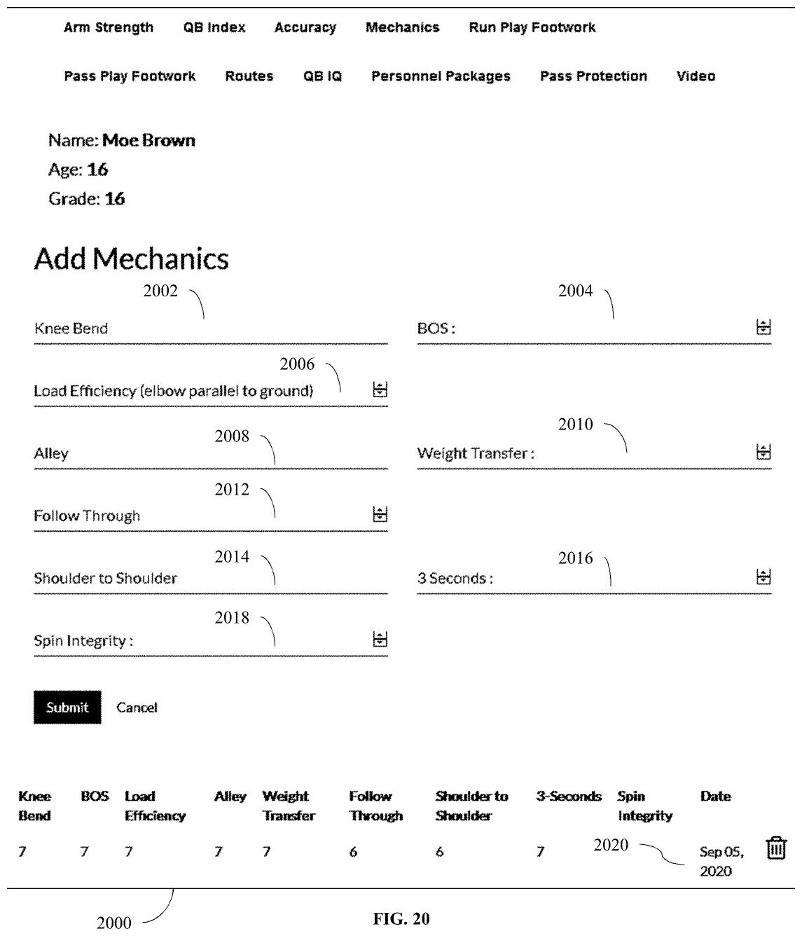

Referencing FIG. 20, user interface 2000 can be provided to input and/or edit data for the Mechanics Skill Group. Input fields can be provided for inputting Skill Scores for Stance/Knee Bend 2002, BOS 2004, Load Efficiency 2006, Alley 2008, Weight Transfer 2010, Follow Through 2012, Shoulder-to-Shoulder 2014, 3-seconds 2016, and Spin Integrity 2018. The input data can be received by application server 10 and stored in the memory 11 along with date data 2020.

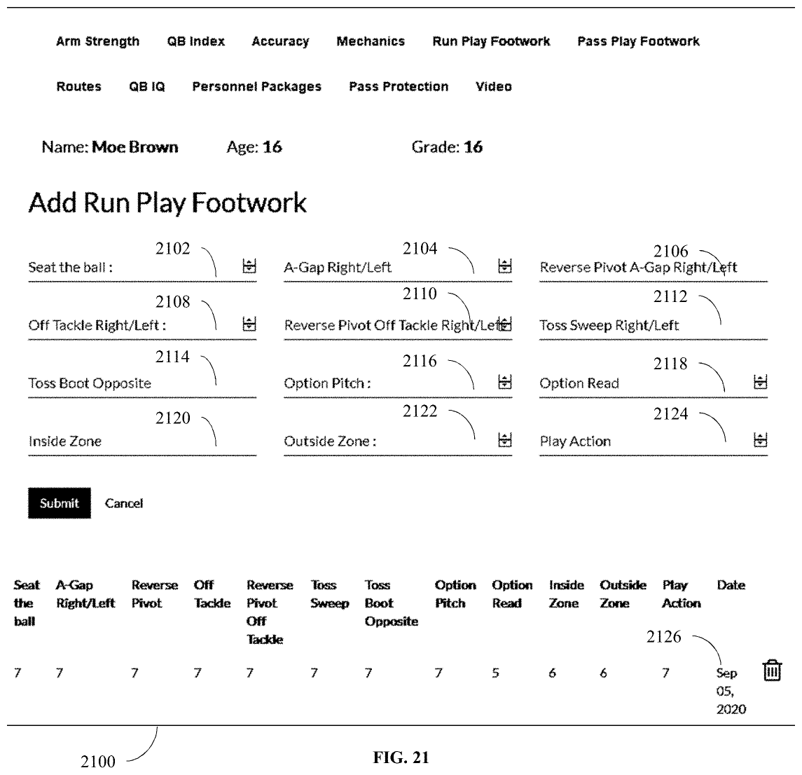

Referencing FIG. 21, user interface 2100 can be provided to input and/or edit data for the Run Play Footwork Skill Group. Input fields can be provided for inputting Skill Scores for Seat the Ball 2102, A-Gap Right/Left 2104, Reverse Pivot A-Gap Right/Left 2106, Off Tackle Right/Left 2108, Reverse Pivot Off Tackle Right/Left 2110, Toss Sweep Right/Left 2112, Toss Boot Opposite 2114, Option Pitch 2116, Option Read 2118, Inside Zone 2120, Outside Zone 2122, and Play Action 2124. The input data can be received by application server 10 and stored in the memory 11 along with date data 2126.

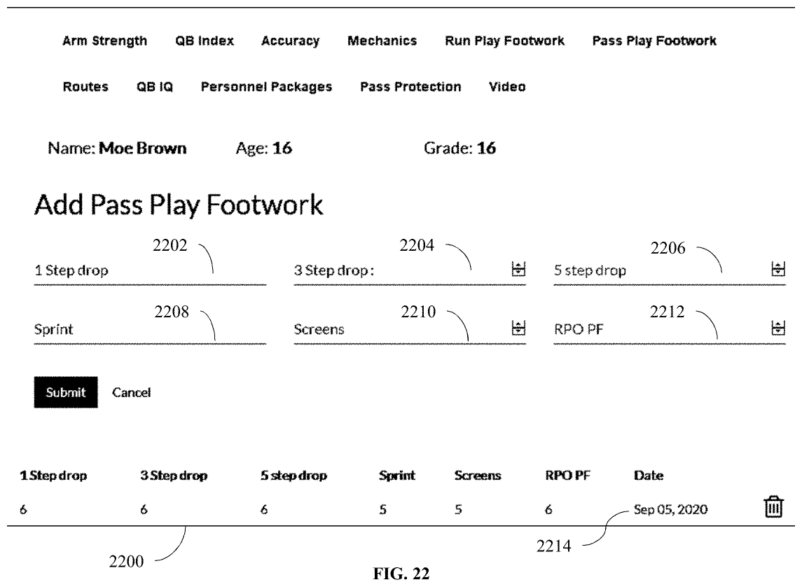

Referencing FIG. 22, user interface 2200 can be provided to input and/or edit data for the Pass Play Footwork Skill Group. Input fields can be provided for inputting Skill Scores for 1-Step Drop 2202, 3-Step Drop 2204, 5-Step Drop 2206, Sprint 2208, Screens 2210, and RPO PF 2212. The input data can be received by application server 10 and stored in the memory 11 along with date data 2214.

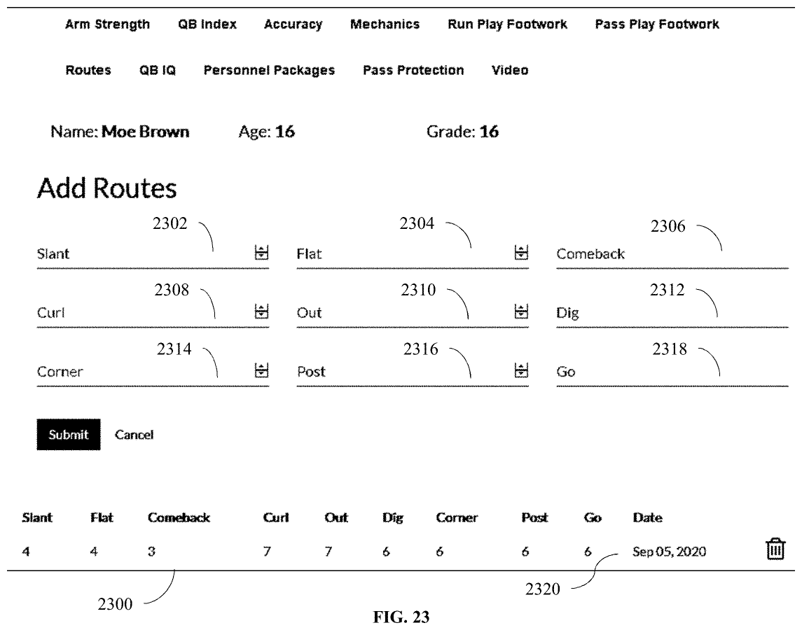

Referencing FIG. 23, user interface 2300 can be provided to input and/or edit data for the Routes Skill Group. Input fields can be provided for inputting Skill Scores for Slant 2302, Flat 2304, Comeback 2306, Curl 2308, Out 2310, Dig 2312, Corner 2314, Post 2316, and Go 2318. The input data can be received by application server 10 and stored in the memory 11 along with date data 2320.

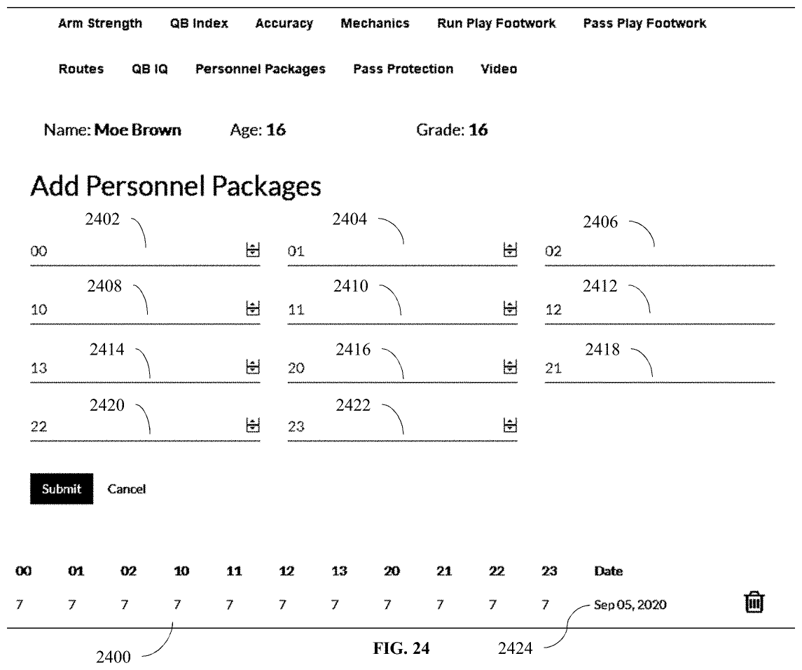

Referencing FIG. 24, user interface 2400 can be provided to input and/or edit data for the Football Personnel Packages Skill Group. Input fields can be provided for inputting Skill Scores for 00 2402, 01 2404, 02 2406, 10 2408, 11 2410, 12 2412, 13 2414, 20 2416, 21 2418, 22 2420, and 23 2422. The input data can be received by application server 10 and stored in the memory 11 along with date data 2424.

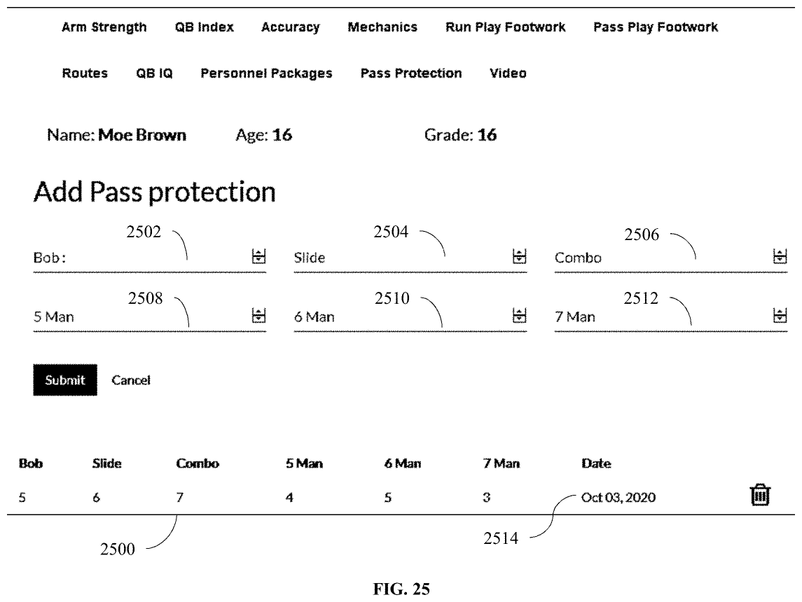

Referencing FIG. 25, user interface 2500 can be provided to input and/or edit data for the Pass Protection Skill Group. Input fields can be provided for inputting Skill Scores for Bob 2502, Slide 2504, Combo 2506, 5-Man 2508, 6-Man 2510, and 7-Man 2512. The input data can be received by application server 10 and stored in the memory 11 along with date data 2514.

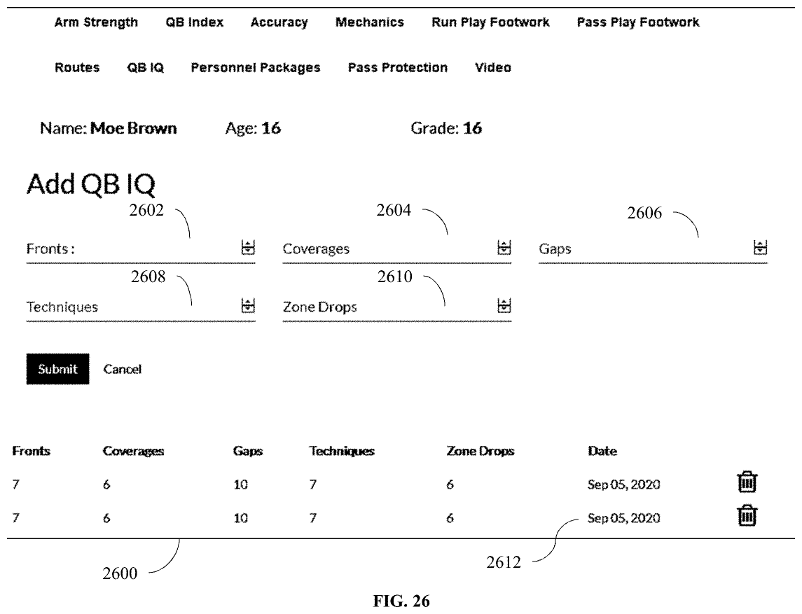

Referencing FIG. 26, user interface 2600 can be provided to input and/or edit data for the QB IQ Skill Group. Input fields can be provided for inputting Skill Scores for Fronts 2602, Coverages 2604, Gaps 2606, Techniques 2608, and Zone Drops 2610. The input data can be received by application server 10 and stored in the memory 11 along with date data 2512.

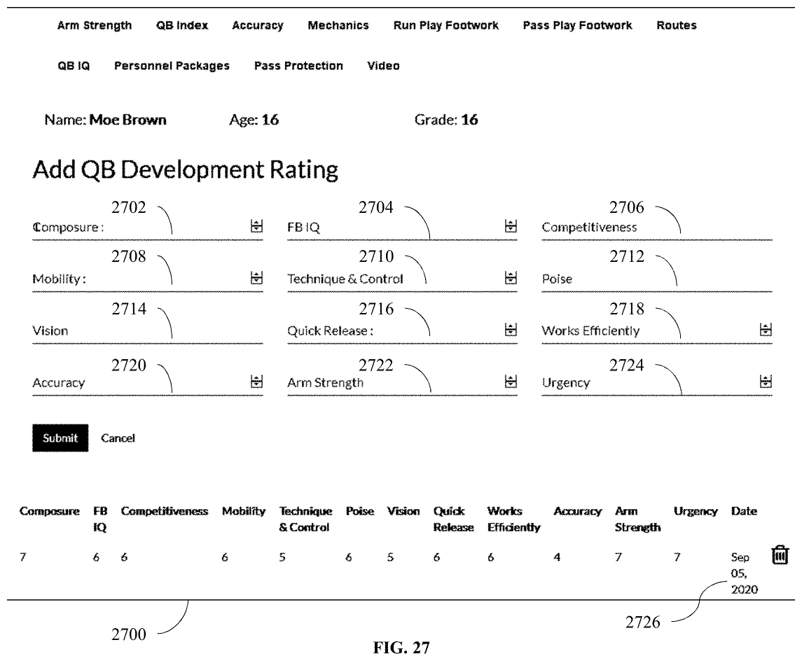

Referencing FIG. 27, user interface 2700 can be provided to input and/or edit data for the QB Development Rating Skill Group. Input fields can be provided for inputting Skill Scores for Composure 2702, QB IQ 2704, Competitiveness 2706, Mobility 2708, Techniques and Control 2710, Poise 2712, Vision 2714, Quick Release 2716, Work Efficiency 2718, Accuracy 2720, Arm Strength 2722, and Urgency 2724. The input data can be received by application server 10 and stored in the memory 11 along with date data 2726.

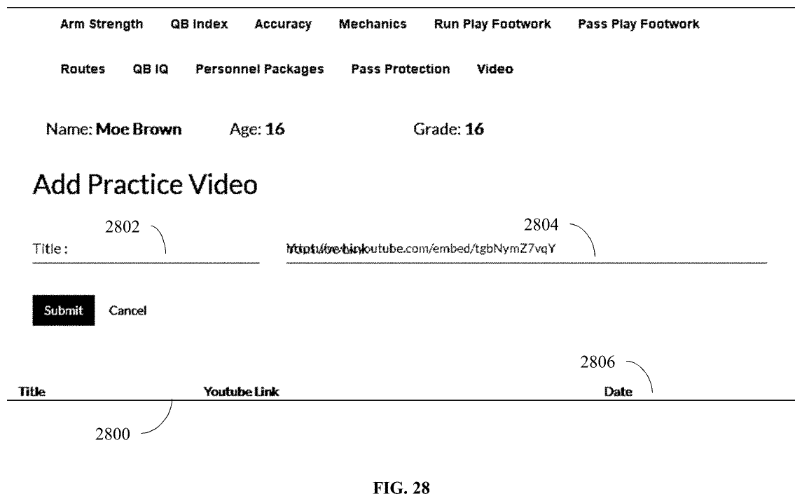

Referencing FIG. 28, user interface 2800 can be provided to input and/or edit data for the Practice Videos associated with a given athlete. Input fields can be provided for inputting Title 2802 and video location 2804. Vide location 2804 input can be, for example, a link (or URL) to a video stored in platform such as YouTube. The input data can be received by application server 10 and stored in the memory 11 along with date data 2806.

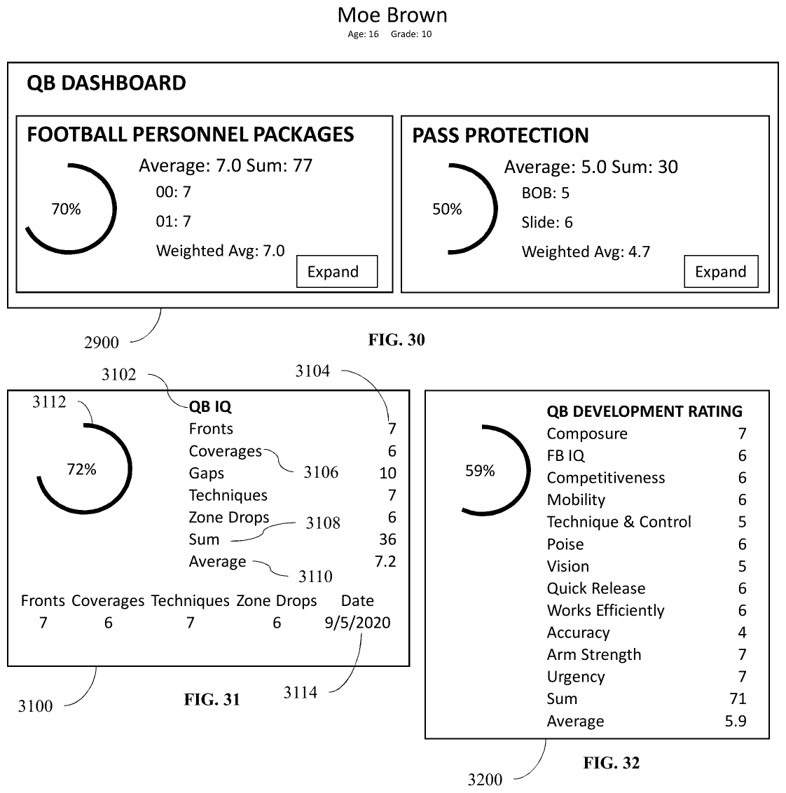

Referencing FIG. 29 and FIG. 30, dashboard 2900 can be provided to display one or more Skill Group Scores and/or Skill Scores. In one embodiment, Skill Group display 2902 can be provided having Skill Group title 2904, the sum 2906, average 2908, and weighted average 2910 of the Skill Scores associated with the Skills included in the Skill Group. Skill Group display 2902 can also include one or more Skill Scores 2912 for at least some of the Skills in the Skill Group. In some embodiments, Skill Group display 2902 can also include graphical display 2914 of, for example, the average 2908. In one embodiment, an input Expand 2916 can be included that, when selected, causes application server 10 to provide detailed display 3200 of the Skill Group and all of the Skills Scores for the Skills included in the Skill Group (see FIG. 32, for example). As illustrated in FIG. 29 and FIG. 30, a Skill Group display can be provided in Dashboard for each of the Skill Groups included in application server 10.

Referencing FIG. 31, Skill Group detailed display 3100 can be provided for providing detail data regarding the Skill Scores associated with all of the Skills included in the Skill Group. Skill Group detailed display 3100 can include Skill Group title 3102, Skill Scores 3104 for each of the Skills 3106 included in the Skill Group, sum 3108 and average 3110 of the Skills Scores 3104, and graphical representation 3112 of the Skill Group Score (in this illustration the Skill Group Score being average 3110). In one embodiment, Skill Group detailed display can also include date data 3114 associated with the Skill Scores 3104.

Referencing FIG. 32 through FIG. 40, Skill Group detailed displays for additional Skill Groups can be provided, such as QB Development Rating detailed display 3200, Accuracy detailed display 3300, Arm Strength detailed display 3400, Mechanics detailed display 3500, Run Play Footwork detailed display 3600, Pass Play Footwork detailed display 3700, Routes detailed display 3800, Football Personnel Packages detailed display 3900, and Pass Protection detailed display 4000.

Referencing FIG. 41, in one embodiment a database in memory 11 can include schema 4100 with a plurality of database tables 4105 to store data for one or more Skill Groups. In the embodiment of FIG. 41, there are tables defined for, for example, Accuracy 4110, Arm Strength 4115, Mechanics 4120, Pass Play 4125, Pass Protection 4130, Football Personnel Packages 4135, QB Index 4140, QB IQ 4145, Routes 4150, and Run Play 4155. Schema 4100 can also include tables for, for example, gender 4160, roles 4165, users 4170, and video 4175.

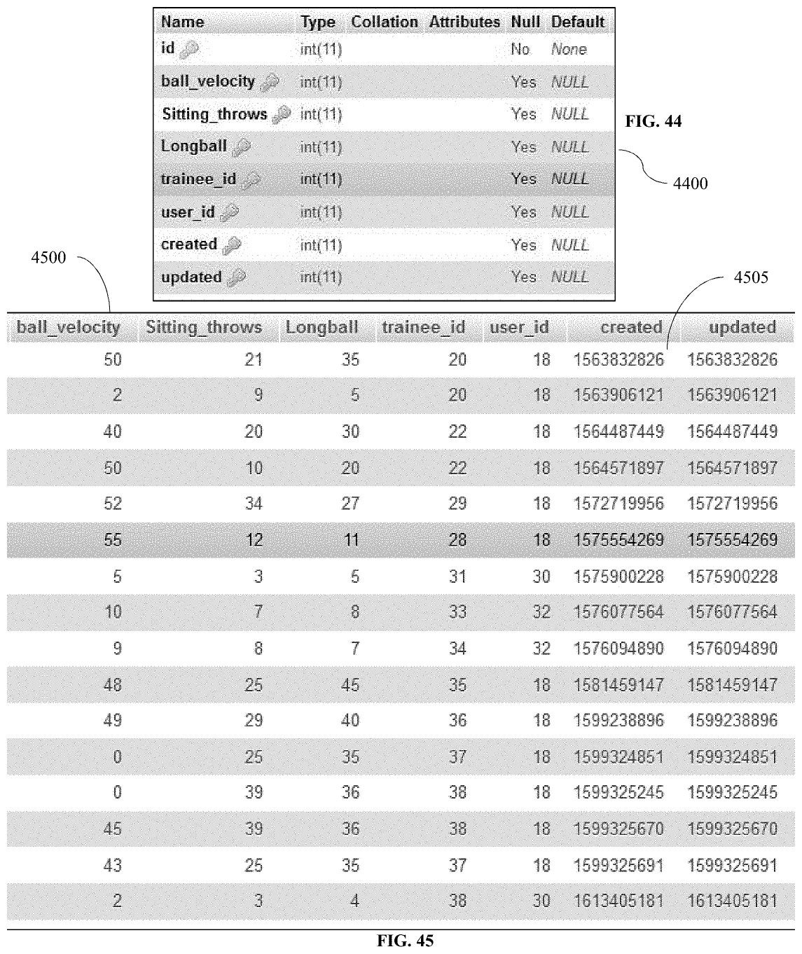

Referencing FIG. 42, in one embodiment Accuracy schema 4200 can be associated with table Accuracy 4110. Referencing FIG. 43, table Accuracy 4110 can include exemplary Accuracy Skills data 4300, including Accuracy date data 4305. Referencing FIG. 44, in one embodiment Arm Strength schema 4400 can be associated with table Arm Strength 4115. Referencing FIG. 45, table Arm Strength 4115 can include exemplary Arm Strength Skills data 4500, including Arm Strength date data 4505.

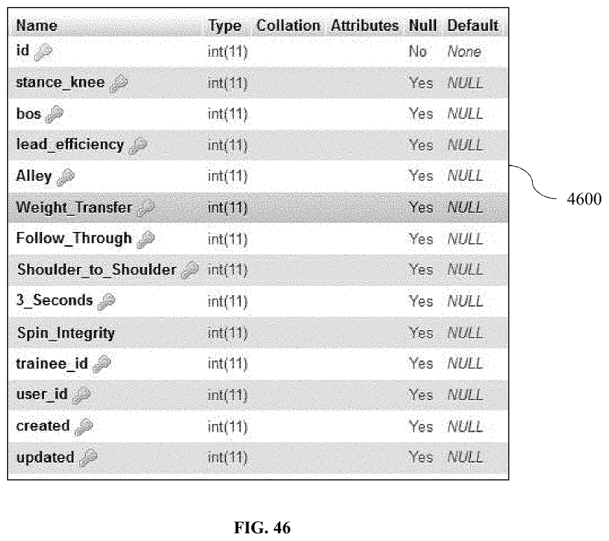

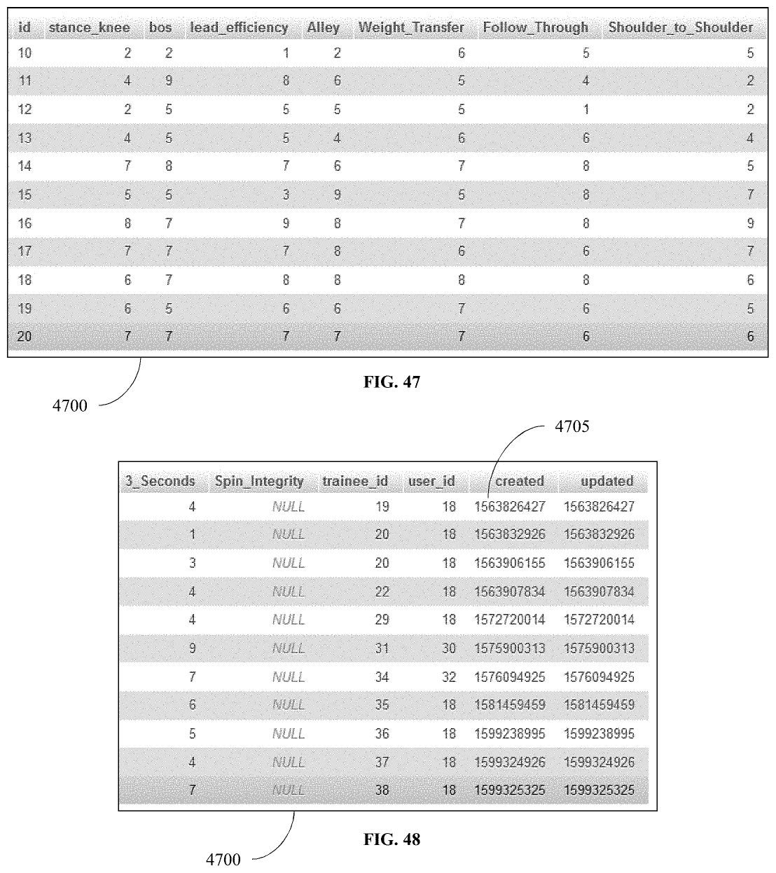

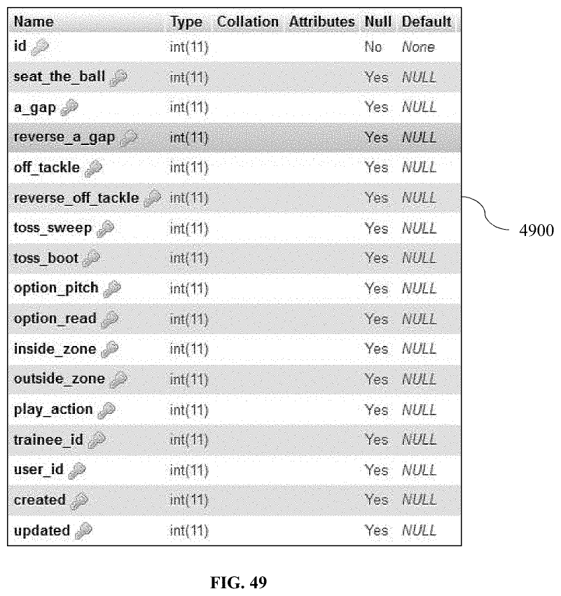

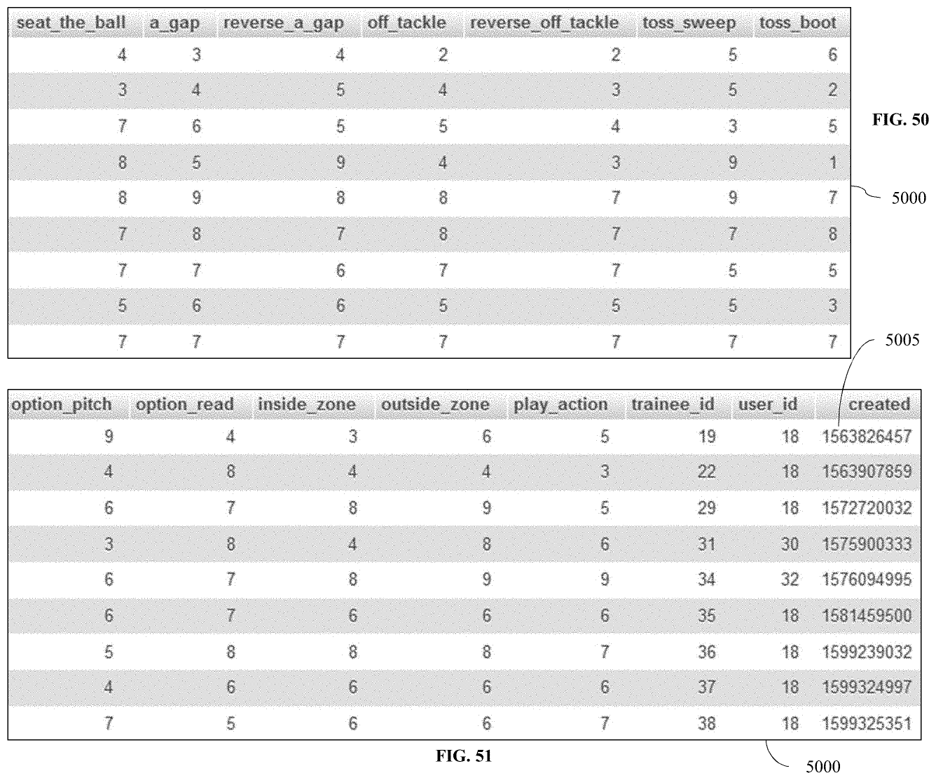

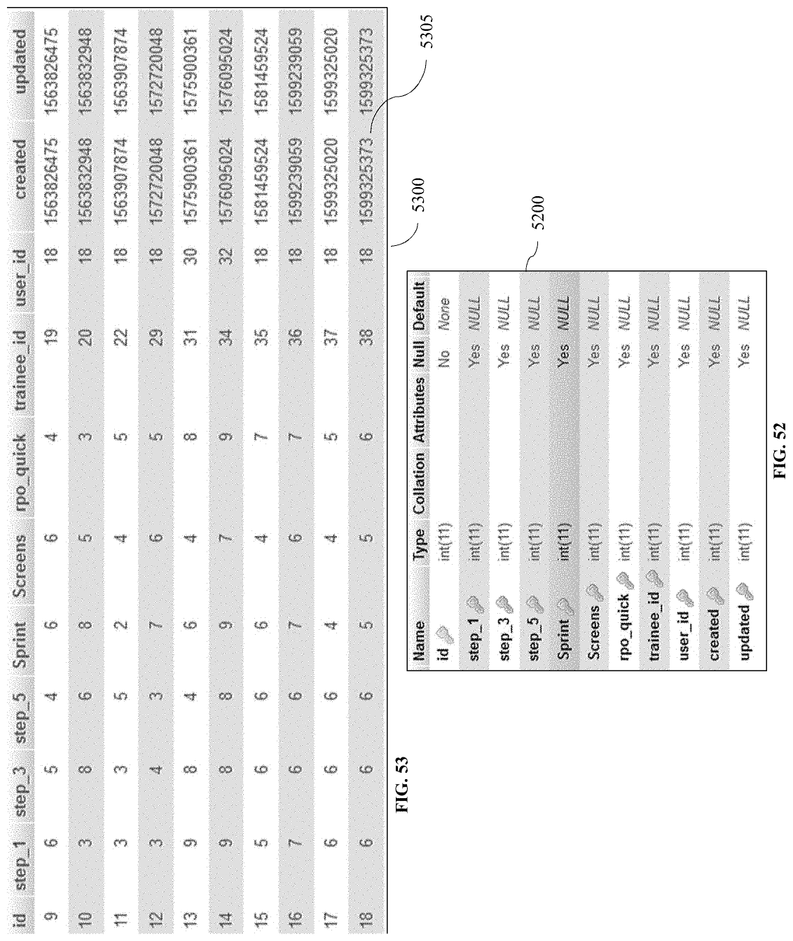

Referencing FIG. 46, in one embodiment Mechanics schema 4600 can be associated with table Mechanics 4120. Referencing FIG. 47 and FIG. 48, table Mechanics 4120 can include exemplary Mechanics Skills data 4700, including Mechanics date data 4705. Referencing FIG. 49, in one embodiment Run Play schema 4900 can be associated with table Run Play 4155. Referencing FIG. 50 and FIG. 51, table Run Play 4155 can include exemplary Run Play Skills data 5000, including Run Play date data 5005. Referencing FIG. 52, in one embodiment Pass Play schema 5200 can be associated with table Pass Play 4125. Referencing FIG. 53, table Pass Play 4125 can include exemplary Pass Play Skills data 5300, including Pass Play date data 5305.

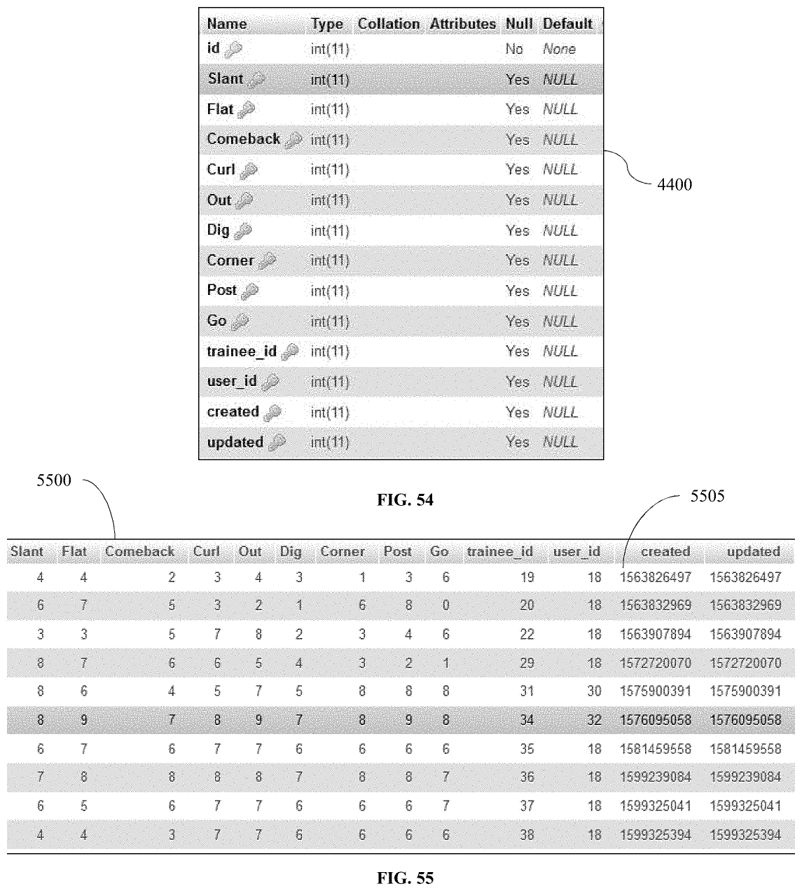

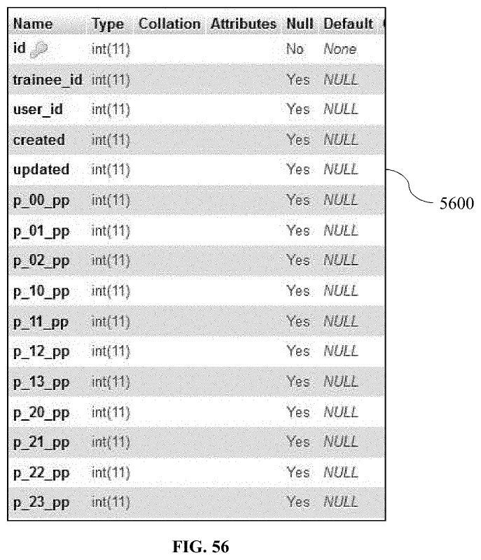

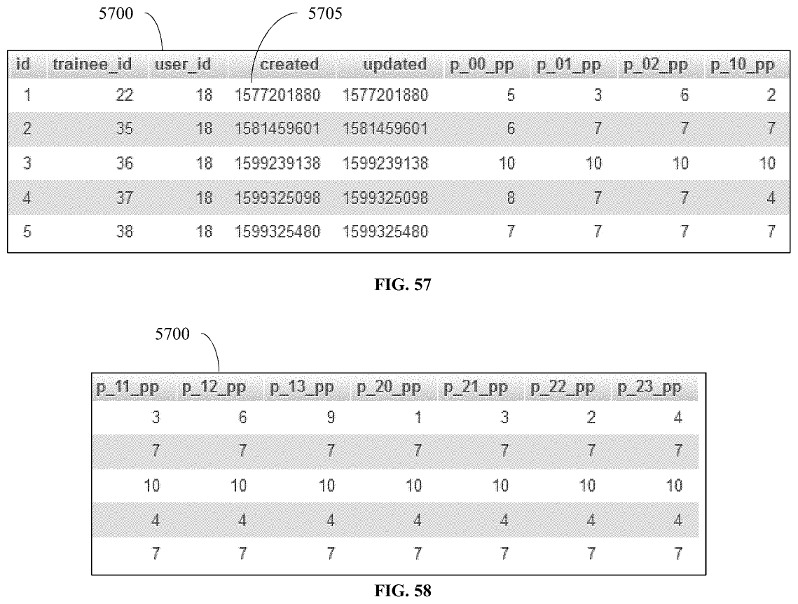

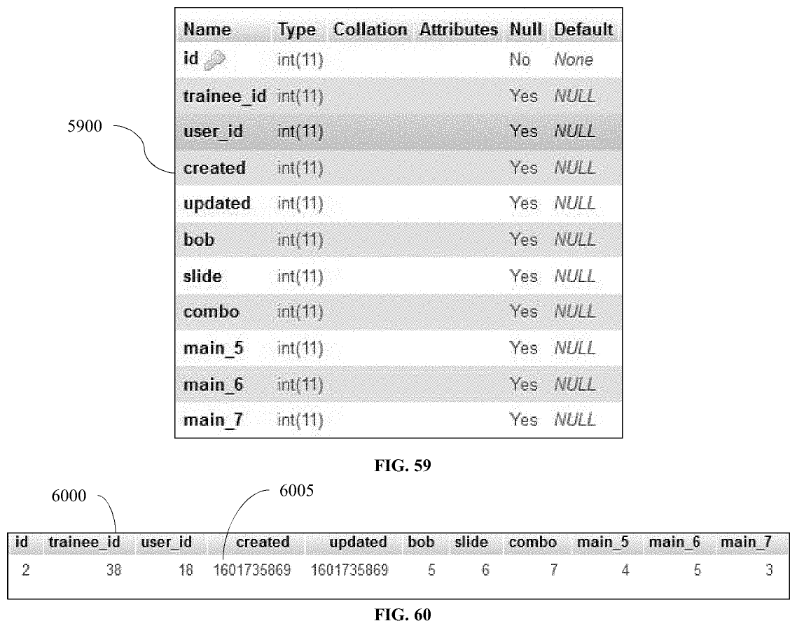

Referencing FIG. 54, in one embodiment Routes schema 5400 can be associated with table Routes 4150. Referencing FIG. 55, table Routes 4150 can include exemplary Routes Skills data 5500, including Routes date data 5505. Referencing FIG. 56, in one embodiment Football Personnel Packages schema 5600 can be associated with table Football Personnel Packages 4135. Referencing FIG. 57 and FIG. 58, table Football Personnel Packages 4135 can include exemplary Football Personnel Packages Skills data 5700, including Football Personnel Packages date data 5705. Referencing FIG. 59, in one embodiment Pass Protection schema 5900 can be associated with table Pass Protection 4130. Referencing FIG. 60, table Pass Protection 4130 can include exemplary Pass Protection data 6000, including Pass Protection date data 6005.

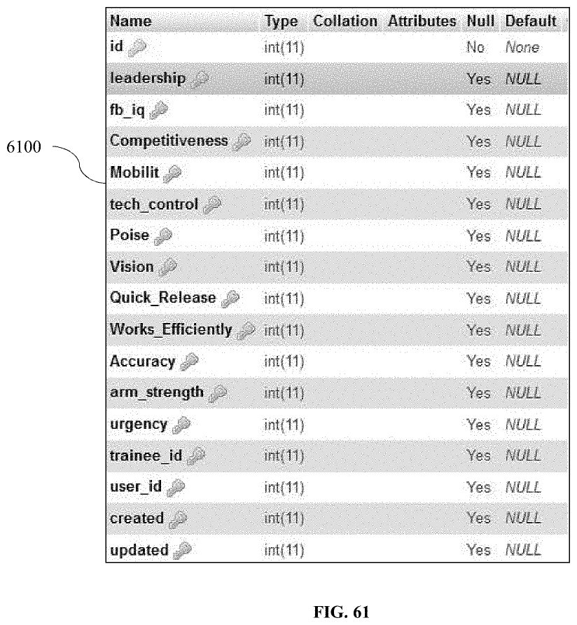

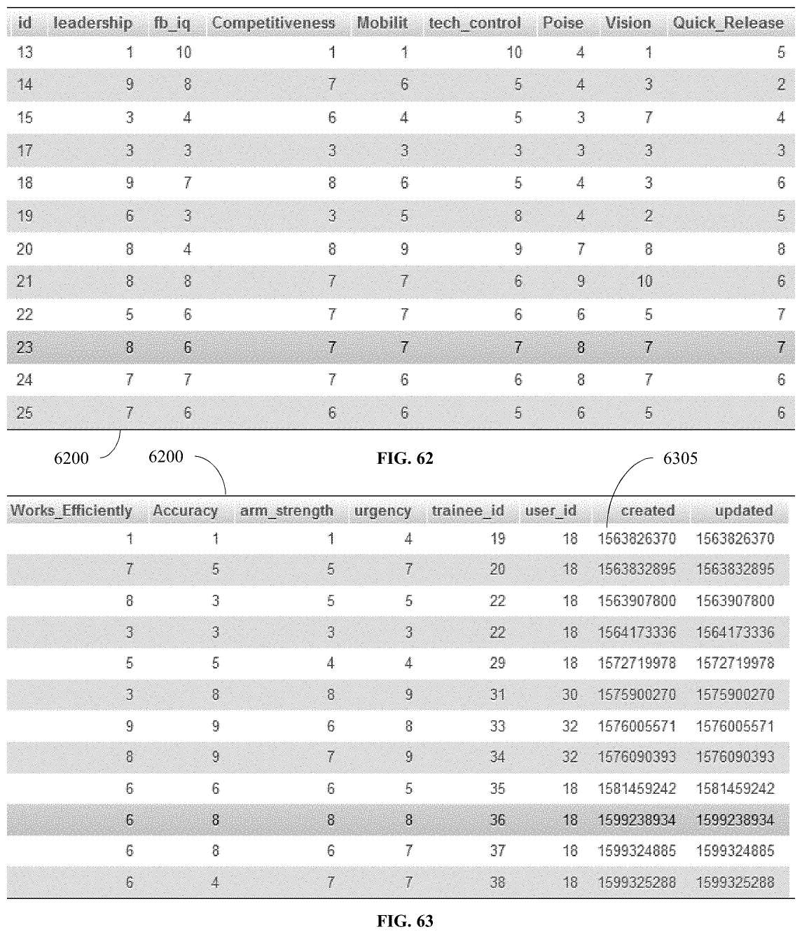

Referencing FIG. 61, in one embodiment QB Index schema 6100 can be associated with table QB Index 4140. Referencing FIG. 62 and FIG. 63, table QB Index 4140 can include exemplary QB Index Skills data 6200, including QB Index date data 6305. Referencing FIG. 64, in one embodiment QB IQ schema 6400 can be associated with table QB IQ 4145. Referencing FIG. 64, table QB IQ 4145 can include exemplary QB IQ data 6500, including QB IQ date data 6505.

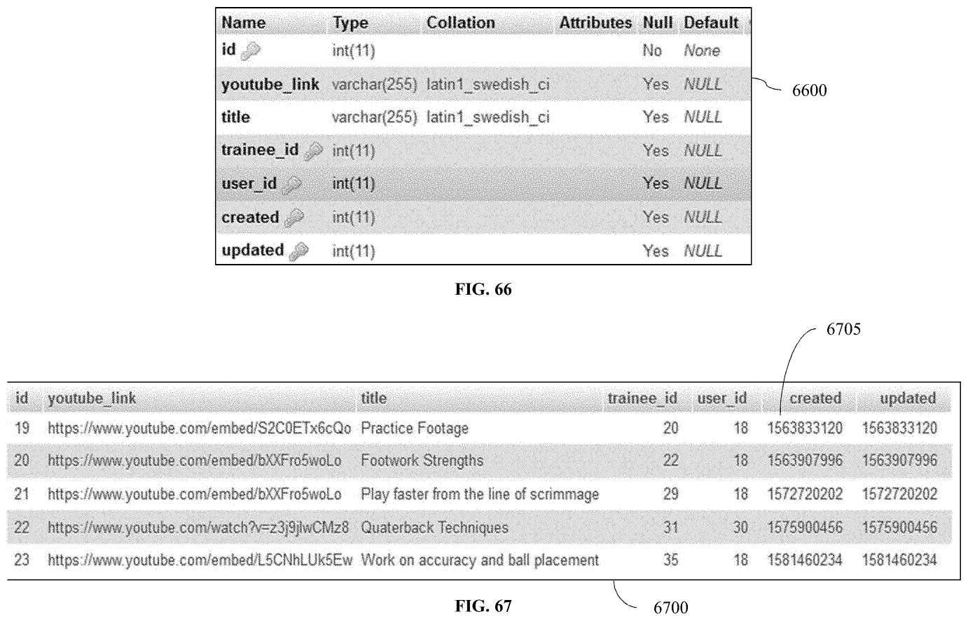

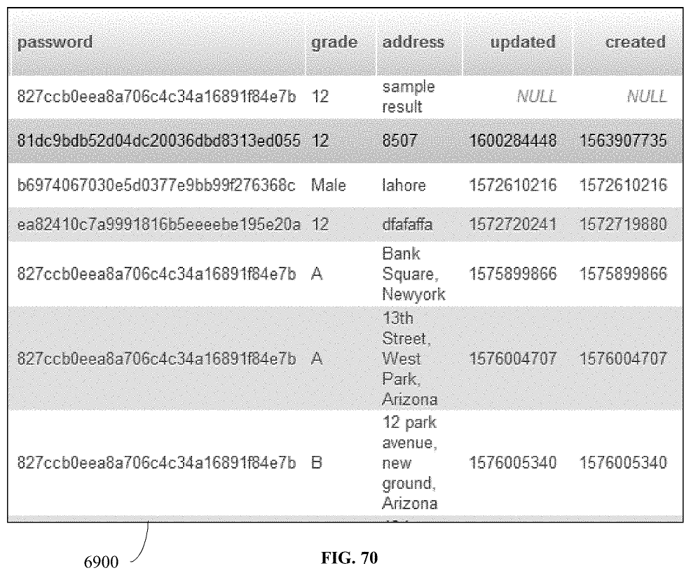

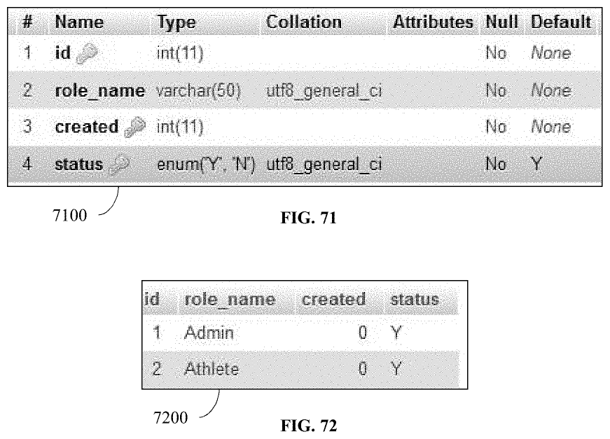

Referencing FIG. 66, in one embodiment video schema 6600 can be associated with table video 4175. Referencing FIG. 67, table video 4175 can include exemplary video data 6700, including video date data 6705. Referencing FIG. 68, in one embodiment users schema 6800 can be associated with table users 4170. Referencing FIG. 69 and FIG. 70, table users 4170 can include exemplary users data 6900. Referencing FIG. 71, in one embodiment roles schema 7100 can be associated with table roles 4165. Referencing FIG. 72, table roles 4165 can include exemplary roles data 7200.

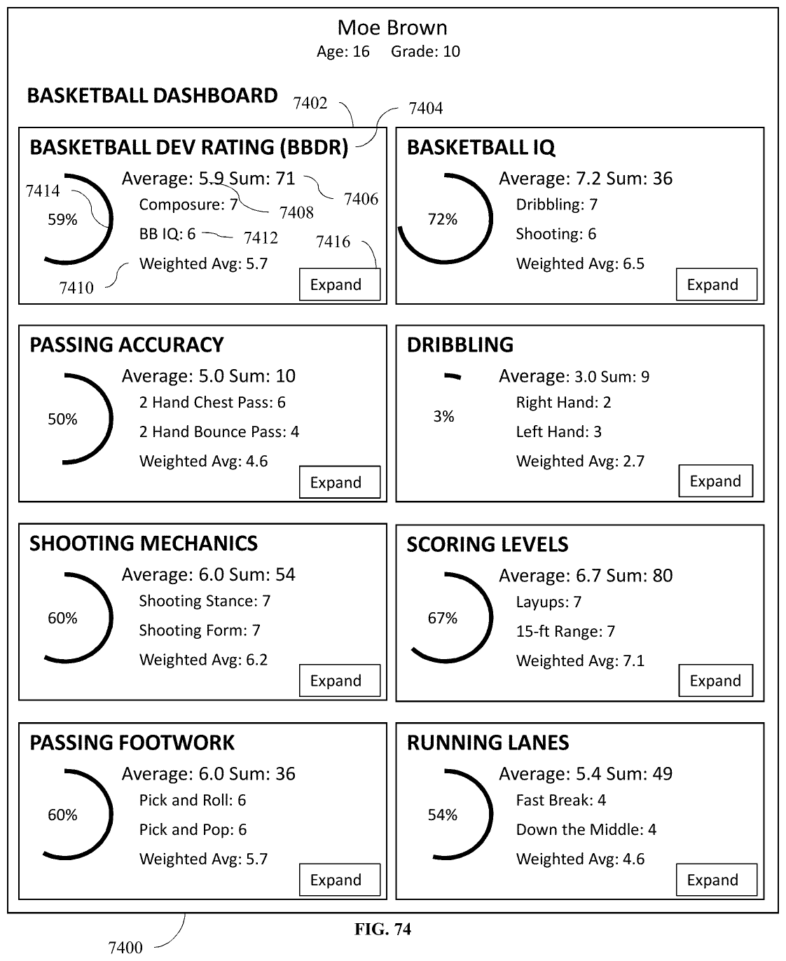

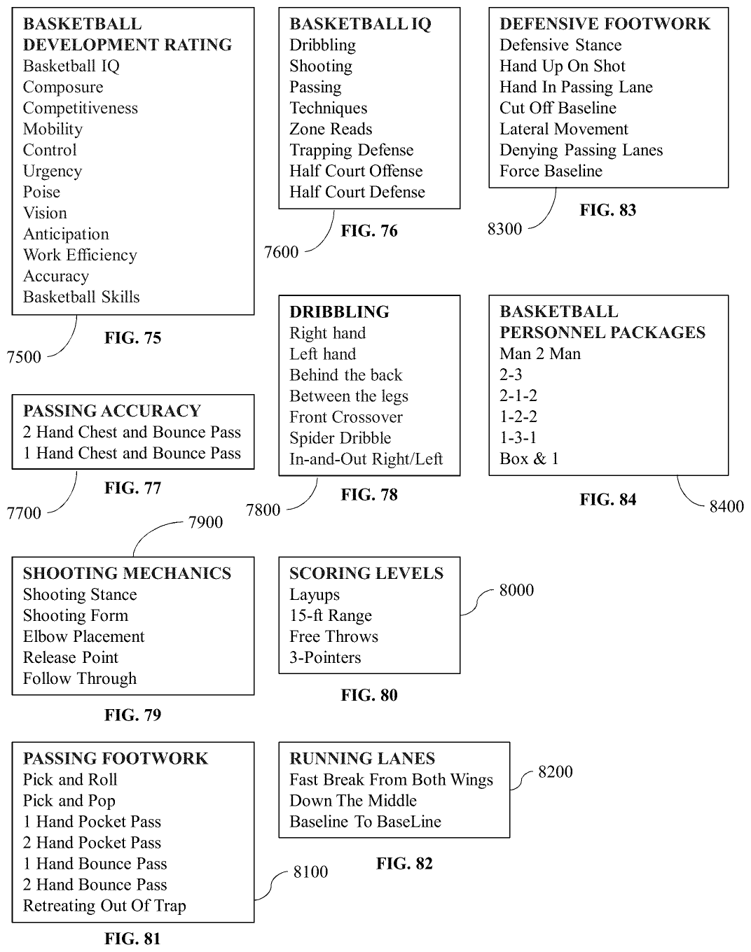

Referencing FIG. 74, dashboard 7400 can be provided to display one or more Skill Group Scores and/or Skill Scores associated with the sport of basketball. In one embodiment, Skill Group display 7402 can be provided having Skill Group title 7404, the sum 7406, average 7408, and weighted average 7410 of the Skill Scores associated with the Skills included in the Skill Group. Skill Group display 7402 can also include one or more Skill Scores 7412 for at least some of the Skills in the Skill Group. In some embodiments, Skill Group display 7402 can also include graphical display 7414 of, for example, the average 7408. In one embodiment, an input Expand 7416 can be included that, when selected, causes application server 10 to provide detailed display 7500 of the Skill Group and all of the Skills included in the Skill Group (see FIG. 75, for example); in some embodiments, detailed display 7500 can also include Skill Scores for each Skill, a sum of Skills Scores, an average of Skill Scores, and/or a weighted average of Skill Scores.

In one embodiment, referencing FIG. 75 through FIG. 84, memory 11 can include Skill Groups for basketball such as Basketball Development Rating 7500, Basketball IQ 7600, Passing Accuracy 7700, Dribbling 7800, Shooting Mechanics 7900, Scoring Levels 8000, Passing Footwork 8100, Running Lanes 8200, Defensive Footwork 8300, and/or Basketball Personnel Packages 8400.

In one embodiment, Basketball Development Rating 7500 can include Skills such as Basketball IQ, Composure, Competitiveness, Mobility, Control, Urgency, Poise, Vision, Anticipation, Work Efficiency, Accuracy, and/or Basketball Skills. In some embodiments, Basketball IQ 7600 can include Skills such as Dribbling, Shooting, Passing, Techniques, Zone Reads, Trapping Defense, Half Court Offense, Half Court Defense.

In certain embodiments, Passing Accuracy 7700 can include Skills such as 2 Hand Chest and Bounce Pass and/or 1 Hand Chest and Bounce Pass. In one embodiment, Dribbling 7800 can include Skills such as Right hand, Left hand, Behind the back, Between the legs, Front Crossover, Spider Dribble, and/or In-and-Out Right/Left.

In some embodiments, Shooting Mechanics 7900 can include Skills such as Shooting Stance, Shooting Form, Elbow Placement, Release Point, and/or Follow Through. In certain embodiments, Scoring Levels 8000 can include Skills such as Layups, 15-ft Range, Free Throws, and/or 3-Pointers.

In one embodiment, Passing Footwork 8100 can include Skills such as Pick and Roll, Pick and Pop, 1 Hand Pocket Pass, 2 Hand Pocket Pass, 1 Hand Bounce Pass, 2 Hand Bounce Pass, and/or Retreating Out Of Trap. In some embodiments, Running Lanes 8200 can include Skills such as Fast Break From Both Wings, Down The Middle, and/or Baseline To Baseline.

In certain embodiments, Defensive Footwork 8300 can include Skills such as Defensive Stance, Hand Up On Shot, Hand In Passing Lane, Cut Off Baseline, Lateral Movement, Denying Passing Lanes, and/or Force Baseline. In one embodiment, Basketball Personnel Packages 8400 can include Skills such as Man 2 Man, 2-3, 2-1-2, 1-2-2, 1-3-1, Box & 1, High Post, Low Post, Wing, and/or Elbow.

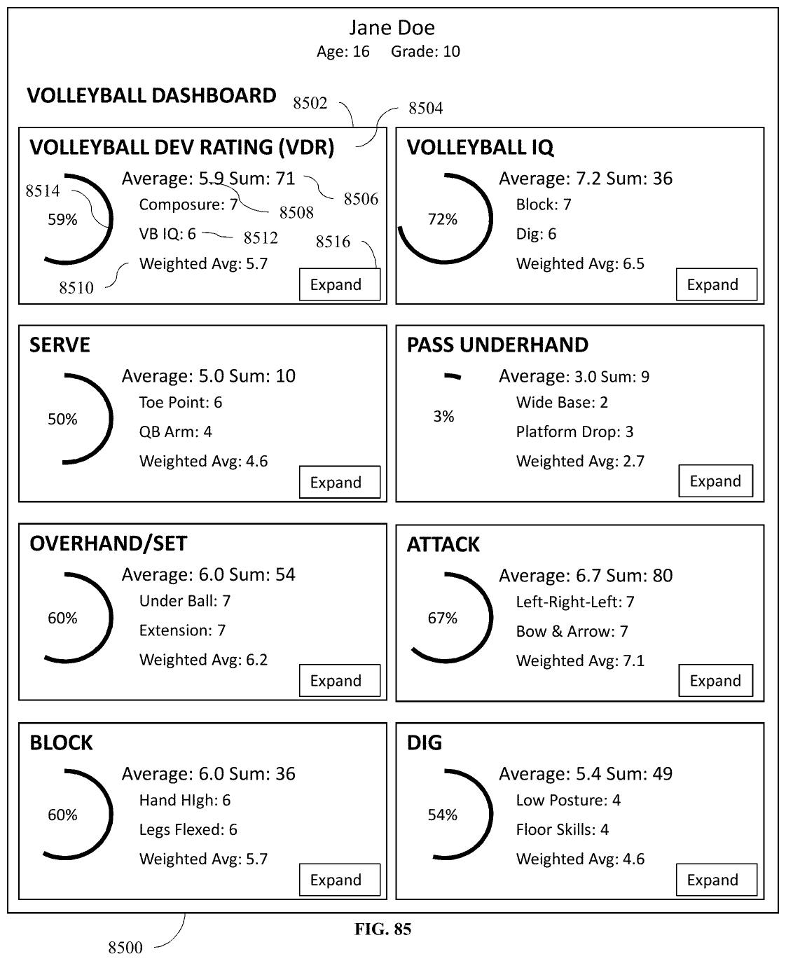

Referencing FIG. 85, dashboard 8500 can be provided to display one or more Skill Group Scores and/or Skill Scores associated with the sport of Volleyball. In one embodiment, Skill Group display 8502 can be provided having Skill Group title 8504, the sum 8506, average 8508, and weighted average 8510 of the Skill Scores associated with the Skills included in the Skill Group. Skill Group display 8502 can also include one or more Skill Scores 8512 for at least some of the Skills in the Skill Group. In some embodiments, Skill Group display 8502 can also include graphical display 8514 of, for example, the average 8508. In one embodiment, an input Expand 8516 can be included that, when selected, causes application server 10 to provide detailed display 8600 of the Skill Group and all of the Skills included in the Skill Group (see FIG. 86, for example); in some embodiments, detailed display 8600 can also include Skill Scores for each Skill, a sum of Skills Scores, an average of Skill Scores, and/or a weighted average of Skill Scores (not shown in FIG. 86).

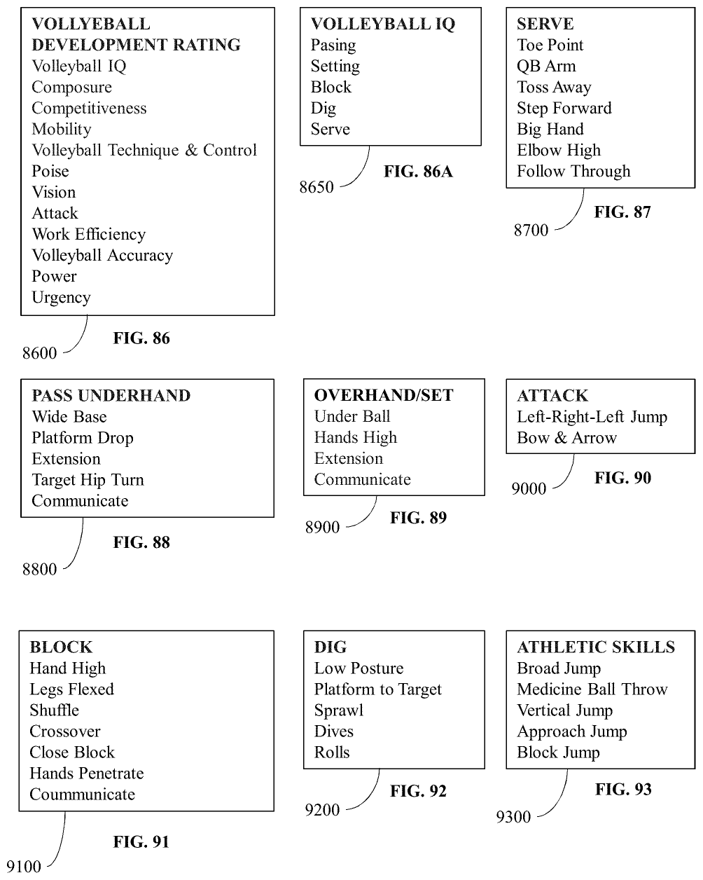

In one embodiment, referencing FIG. 85 through FIG. 96, memory 11 can include Skill Groups for volleyball such as Volleyball Development Rating 8600, Volleyball IQ 8650, Serve 8700, Pass Underhand 8800, Overhand/Set 8900, Attack 9000, Block 9100, Dig 9200, Movement/Footwork 9300, Attitude 9400, Coachable/Leadership 9500, and/or Athletic Skills 9600.

In one embodiment, Volleyball Development Rating 8600 can include Skills such as Volleyball IQ, Composure, Competitiveness, Mobility, Volleyball Technique & Control, Poise, Vision, Attack, Work Efficiency, Accuracy, Power, and/or Urgency. In certain embodiments, Volleyball IQ 8650 can include Skills such as passing, setting, Block, Dig, and Serve.

In some embodiments, Serve 8700 can include Skills such as Toe Point, QB Arm, Toss Away, Step Forward, Big Hand, Elbow High, and/or Follow Through. In certain embodiments, Pass Underhand 8800 can include Skills such as Wide base, Platform Drop, Extension, Target Hip Turn, and/or Communicate. In one embodiment, Overhand/Set 8900 can include Skills such as Under Ball, Hands High, Extension, and/or Communicate.

In some embodiments, Attack 9000 can include Skills such as Left-Right-Left Jump and/or Bow & Arrow. In certain embodiments, Block 9100 can include Skills such as Hand High, Legs Flexed, Shuffle, Crossover, Close Block, Hands Penetrate, and/or Communicate. In one embodiment, Dig 9200 can include Skills such as Low Posture, Platform to Target, and/or Floor Skills (for example, Sprawl, Dives, and/or Rolls). In some embodiments, Athletic Skills 9300 can include Skills such as Broad Jump, Medicine Ball Throw, Vertical Jump, Approach Jump, and/or Block Jump.

In one embodiment, the method involves compiling data focused on an athlete's skills development, rather than (or in addition to) collecting data for traditional measurements, such as 40-yard dash or broad jump. The method can use weighted measurements for key skill development areas to provide athletes with a depiction of their athletic skills development progress over time. In some embodiments, the method uses certain Skills Groups together to derive a Skill Group Score, such as QB IQ and QBDR. Because in certain cases objective data is insufficient to rate an athlete's skill development, in some embodiments the method includes subjective assessments such Competitiveness.

While the invention has been described with reference to exemplary embodiments, it will be understood by those skilled in the relevant technology that various changes may be made and equivalents may be substituted for elements thereof without departing from the scope of the invention. In addition, many modifications may be made to adapt a particular system, device or component thereof to the teachings of the invention without departing from the essential scope thereof. Therefore, it is intended that the invention not be limited to the particular embodiments disclosed for carrying out this invention.

What is claimed is:

1. A system for facilitating athletic skill development, the system comprising:
a database for storing data associated with an athlete;
a computer processor and a computer memory for executing program modules;
a computer display monitor for displaying data associated with the athlete;
one or more program modules for execution by the computer processor in conjunction with the computer memory, wherein the one or more program modules comprise instructions for:
building a database for storing information associated with an athlete;
receiving input for defining a plurality of Skills and a plurality of Skill Groups;
providing an entry in the database for each of the Skills;
storing in the database, for each of the Skills, a Skill Score for the athlete;
storing in the database date data associated with the Skill Score;
receiving input for assigning a Skill Group to each Skill;
determining a plurality of Skill Group Scores by adding the Skill Scores of each Skill in a Skill Group;
receiving input for identifying one of the plurality of Skill Group Scores as an Athlete Development Rating (ADR);
displaying with the computer display monitor the ADR, one or more Skill Group Scores, and one or more Skill Scores; and
displaying with the computer display monitor historical data based at least in part on the stored date data for the ADR, one or more Skill Group Scores, and/or one or more Skill Scores.

2. The system of claim 1, wherein the program modules further comprise instructions for displaying in real time the ADR in conjunction with storing a Skill Score substantially concurrently with an evaluation of the athlete in a Skill.

3. A method of facilitating athletic skill development, the method comprising:
providing a database for storing data associated with an athlete;
defining a plurality of Skills and a plurality of Skill Groups;
providing an entry in the database for each of the Skills;
storing in the database, for each of the Skills, a Skill Score for the athlete;
storing in the database date data associated with the Skill Score;
assigning a Skill Group to each Skill;
determining a plurality of Skill Group Scores by adding the Skill Scores of each Skill in a Skill Group;
identifying one of the plurality of Skill Group Scores as an Athlete Development Rating (ADR);
displaying the ADR, one or more Skill Group Scores, and one or more Skill Scores; and
displaying historical data based at least in part on the stored date data for the ADR, one or more Skill Group Scores, and/or one or more Skill Scores.

4. The method of claim 3, further comprising determining an average of the Skill Scores for a Skill Group.

5. The method of claim 4, further comprising displaying said average.

6. The method of claim 3, wherein the ADR is the Skill Group Score for a Skill Group comprising the Skills QB IQ, Mobility, Technique and Control, Quick Release, and Accuracy.

7. The method of claim 3, wherein determining a plurality of Skill Group Scores comprises adding the Skill Scores multiplied by a weight.

8. The method of claim 3, further comprising displaying in real time the ADR, in conjunction with storing a Skill Score substantially concurrently with an evaluation of the athlete in a Skill.

9. The method of claim 3, wherein the plurality of Skills Groups comprises Basketball IQ, Passing Accuracy, Dribbling, Shooting Mechanics, Scoring Levels, Passing Footwork, Running Lanes, and Defensive Footwork.

10. The method of claim 3, wherein the plurality of Skills Groups comprises Volleyball IQ, Serve, Pass Underhand, Overhand/Set, Attack, Block, Dig, Movement/Footwork, Attitude, Coachable/Leadership, and/or Athletic Skills.

11. The method of claim 3, wherein the plurality of Skill Groups comprises Accuracy, Arm Strength, Mechanics, Pass Play Footwork, Pass Protection, and QB IQ.

12. The method of claim 11, wherein the Mechanics Skill Group comprises the Skills Stance/Knee Bend, Load Efficiency, Weight Transfer, and Follow Through.

13. The method of claim 11, wherein the Pass Play Footwork Skill Group comprises the Skills 3-Step Drop, 5-Step Drop, and Sprint.

14. The method of claim 11, wherein the Routes Skill Group comprises the Skills Slant, Comeback, Curl, Out, Corner, and Post.

15. The method of claim 11, wherein the Pass Protection Skill Group comprises the Skills 5-Man, 6-Man, and 7-Man.

16. The method of claim 11, wherein the QB IQ Skill Group comprises the Skills Fronts, Coverages, Gaps, Techniques, and Zone Drops.

17. A method of facilitating athletic skill development, the method comprising:
storing in a database a Skill Score for each of a plurality of Skills;
determining an Athlete Development Rating (ADR) based at least in part on the Skill Scores; and
displaying the ADR and one or more Skill Scores.

18. The method of claim 17, the method further comprising:
assigning to each of the plurality of Skills one of a plurality of Skill Groups;
storing in the database date data associated with each Skill Score;
determining a plurality of Skill Group Scores by adding the Skill Scores of each Skill in a Skill Group; and
displaying historical data based at least in part on the stored date data for the ADR, one or more Skill Group Scores, and/or one or more Skill Scores.

19. The method of claim 18, wherein the plurality of Skills Groups comprises Basketball IQ, Passing Accuracy, Dribbling, Shooting Mechanics, Scoring Levels, Passing Footwork, Running Lanes, and Defensive Footwork.

20. The method of claim 18, wherein the plurality of Skills Groups comprises Volleyball Development Rating, Volleyball IQ, Serve, Pass Underhand, Overhand/Set, Attack, Block, Dig, and/or Athletic Skills.
